(19) United States
(12) Patent Application Publication
(10) Pub. No.: US 2009/0103029 A1
(43) Pub. Date: Apr. 23, 2009

(54) LIQUID CRYSTAL PANEL AND LIQUID CRYSTAL DISPLAY APPARATUS

(75) Inventors: Junzo Miyazaki, Osaka (JP); Shouichi Matsuda, Osaka (JP); Tatsuki Nagatsuka, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/300,929

(22) PCT Filed: Jan. 18, 2008
(86) PCT No.: PCT/JP2008/050637

§ 371 Date: Nov. 14, 2008

(30) Foreign Application Priority Data
Feb. 27, 2007 (JP) 2007-046452

(51) Int. Cl. G02F 1/13363; G02F 1/1335

(52) U.S. Cl. 349/118; 428/1.31

(57) ABSTRACT

Provided are a liquid crystal panel and a liquid crystal display apparatus with a high contrast ratio in an oblique direction, less light leakage, a small color shift in an oblique direction, and extremely small thickness. The liquid crystal panel of the present invention includes a liquid crystal cell, a first polarizer arranged on one side of the liquid crystal cell, an optical element (A), an optical element (B), and a second polarizer arranged on the other side of the liquid crystal cell. The optical element (A) exhibits a refractive index ellipsoid of nx>nz>ny, is formed of a specific polycyclic compound, and has an Nz coefficient of 0.05 to 0.45. The optical element (B) exhibits a refractive index ellipsoid of nx>nz>ny and has an Nz coefficient of 0.55 to 0.95.

### TECHNICAL FIELD

The present invention relates to a liquid crystal panel having a liquid crystal cell, a polarizer, and an optical element. The present invention also relates to a liquid crystal display apparatus using the above liquid crystal panel.

### BACKGROUND ART

A liquid crystal display apparatus has noticeable features such as thinness, light weight, and low power consumption. Therefore, the liquid crystal display apparatus has been widely used in mobile equipment such as a cellular phone and a watch, OA equipment such as a personal computer monitor and a notebook computer, household electric products such as a video camera and a liquid crystal television, and the like. The reason why the liquid crystal display apparatus has been widely used as such is that the defects such as the variation in display characteristics depending upon the viewing angle of a screen, and the malfunction caused by a high temperature, an extremely low temperature, or the like are being overcome by technical innovation. However, as applications cover a broader range, various properties tailored for the respective applications have been required. For example, in a conventional liquid crystal display apparatus, regarding the viewing angle properties, it has been considered sufficient that a contrast ratio of white/black displays may be about 10 in an oblique direction. This definition is derived from the contrast ratio of black ink printed on white paper such as newspaper and a magazine. However, in a stationary large television application, a number of people watch a screen concurrently, so a display that can be viewed well even from different viewing angles is required. That is, the contrast ratio of white/black displays is required to be, for example, 20 or more. Further, in the case of a large display, even if viewers do not move, watching four corners of a screen is equivalent to watching a screen in different viewing angle directions. Therefore, it is important that a display is uniform without unevenness over the entire screen of the liquid crystal panel.

At present, a liquid crystal display apparatus (for example, used for a television application) having a liquid crystal cell widely adopts an in-plane switching (IPS) system as one drive mode. This system is characterized in that liquid crystal molecules homogeneously aligned in the absence of an electric field are driven with a lateral electric field, whereby a display with a vivid color can be obtained. However, in the conventional liquid crystal display apparatus having a liquid crystal cell of an IPS system, there are problems of deterioration in display characteristics, such as the decrease in a contrast ratio in an oblique direction and the coloring of an image that varies depending upon the viewing angle (which is also referred to as a color shift in an oblique direction).

In order to solve the above problems, it has been disclosed that the display characteristics in an oblique direction can be improved, using a λ/2 plate exhibiting a refractive index profile of nx>nz>ny (it should be noted that the refractive indices in a slow axis direction, a fast axis direction, and a thickness direction of a film are respectively defined as nx, ny, and nz) (for example, Patent Document 1).

The above λ/2 plate exhibiting a refractive index profile of nx>nz>ny is produced by attaching shrinkable films on both sides of a polymer film, and stretching the resultant polymer film so that it expands in a thickness direction. Therefore, the thickness of the λ/2 plate to be produced becomes large, which makes it difficult to reduce the thickness of a liquid crystal display apparatus.

### Patent Document 1: JP 2006-72309 A

### DISCLOSURE OF THE INVENTION

### Problems to be Solved by the Invention

An object of the present invention is to provide very thin liquid crystal panel and liquid crystal display apparatus with a high contrast ratio in an oblique direction, less light leakage, and a small color shift in an oblique direction.

### Means for Solving the Problems

A liquid crystal panel of the present invention includes: a liquid crystal cell; a first polarizer arranged on one side of the liquid crystal cell; a second polarizer arranged on the other side of the liquid crystal cell; an optical element (A) arranged between the first polarizer and the liquid crystal cell; and an optical element (B) arranged between the optical element (A) and the liquid crystal cell, and, in the liquid crystal panel,

the optical element (A) exhibits a refractive index ellipsoid of nx>nz>ny, is formed of one or more kinds of polycyclic compounds each having a —SO₃M group and/or a —COOM group (M represents a counter ion), and has an Nz coefficient of 0.05 to 0.45, and the optical element (B) exhibits a refractive index ellipsoid of nx>nz>ny and has an Nz coefficient of 0.55 to 0.95.

In a preferred embodiment, the polycyclic compound which forms the above optical element (A) has a heterocycle.

In a preferred embodiment, a nitrogen atom is incorporated as a heteroatom in the heterocycle possessed by the polycyclic compound which forms the optical element (A).

In a preferred embodiment, the polycyclic compound which forms the above optical element (A) is represented by General Formula (1).

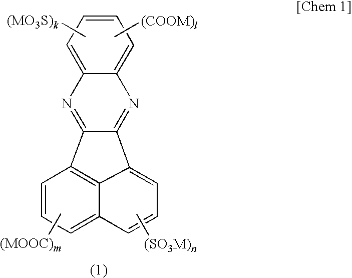

(in General Formula (1), M represents a counter ion, k and l each represent integers of 0 to 4 independently, the sum of k and l is an integer of 0 to 4, m and n each represent integers of 0 to 6 independently, the sum of m and n is an integer of 0 to 6, and k, l, m and n do not represent 0 at the same time.)

In a preferred embodiment, an in-plane retardation Re[590] of the above optical element (A) at a wavelength of 590 nm and 23° C. is 100 to 400 nm.

In a preferred embodiment, a thickness of the above optical element (A) is 0.05 to 10 μm.

In a preferred embodiment, the above optical element (B) includes a stretched film obtained by attaching a shrinkable film on one or both sides of a polymer film and stretching the resultant polymer film under heat.

In a preferred embodiment, an in-plane retardation Re[590] of the above optical element (B) at a wavelength of 590 nm and 23° C. is 100 to 400 nm.

In a preferred embodiment, a thickness of the above optical element (B) is 0.05 to 10 μm.

In a preferred embodiment, the liquid crystal panel further includes an optical element (C) between the above first polarizer and the above optical element (A), and the absolute value of a thickness direction retardation value Rth[590] of the optical element (C) measured at a wavelength of 590 nm and 23° C. is 10 nm or less.

In a preferred embodiment, the above optical element (C) includes a polymer film containing, as a main component, at least one selected from a cellulose ester, a cycloolefin-based resin obtained by hydrogenating a ring-opening polymer of a norbornene-based monomer, an addition copolymer of a norbornene-based monomer and an α-olefin monomer, and an addition copolymer of a maleimide-based monomer and an olefin monomer.

In a preferred embodiment, the liquid crystal panel further includes an optical element (D) between the above second polarizer and the above liquid crystal cell, and the absolute value of a thickness direction retardation value Rth[590] of the optical element (D) measured at a wavelength of 590 nm and 23° C. is 10 nm or less.

In a preferred embodiment, the optical element (D) includes a polymer film containing, as a main component, at least one selected from a cellulose ester, a cycloolefin-based resin obtained by hydrogenating a ring-opening polymer of a norbornene-based monomer, an addition copolymer of a norbornene-based monomer and an α-olefin monomer, and an addition copolymer of a maleimide-based monomer and an olefin monomer.

In a preferred embodiment, the slow axis of the optical element (A) is substantially perpendicular to the absorption axis of the above first polarizer.

In a preferred embodiment, the slow axis of the optical element (B) is substantially perpendicular to the absorption axis of the above first polarizer.

In a preferred embodiment, a drive mode of the above liquid crystal cell is an IPS mode.

According to another aspect of the present invention, a liquid crystal display apparatus is provided. The liquid crystal display apparatus includes the above liquid crystal panel.

### EFFECTS OF THE INVENTION

According to the present invention, very thin liquid crystal panel and liquid crystal display apparatus with a high contrast ratio in an oblique direction, less light leakage, and a small color shift in an oblique direction can be provided.

The above effect can be expressed by arranging an optical element (A) and an optical element (B) having particular optical properties, and a liquid crystal cell in a particular positional relationship, and forming optical element (A) exhibiting a refractive index ellipsoid of nx>nz>ny of a particular polycyclic compound.

### BRIEF DESCRIPTION OF THE DRAWINGS

FIG. 1 is a schematic sectional view of a liquid crystal panel according to a preferred embodiment of the present invention.

FIG. 2A is a schematic perspective view of the liquid crystal panel of FIG. 1 employing O-mode, and

FIG. 2B is a schematic perspective view of the liquid crystal panel of FIG. 1 employing E-mode.

FIG. 3 is a schematic view illustrating a concept of a typical production process of a polarizer used in the present invention.

FIG. 4 is a schematic sectional view of a liquid crystal display apparatus according to a preferred embodiment of the present invention.

FIG. 5 is a radar chart diagram of a liquid crystal panel obtained in Example 1.

FIG. 6 is a radar chart diagram of a liquid crystal panel obtained in Comparative Example 1.

### DESCRIPTION OF REFERENCE NUMERALS

10 liquid crystal cell
11, 11′ substrate
12 liquid crystal layer
21 first polarizer
22 second polarizer
30 optical element (C)
40 optical element (A)
50 optical element (B)
60 optical element (D)
65, 65′ protective layer
70, 70′ surface-treated layer
80 brightness enhancement film
110 prism sheet
120 light guide plate
130 lamp
100 liquid crystal panel
200 feeding part
210 iodide aqueous solution bath
220 bath of aqueous solution containing boric acid and potassium iodide
230 aqueous solution bath containing potassium iodide
240, 309 drying means
250 polarizer
260 take-up part
301 first feeding part
302 polymer film
303 second feeding part
304, 306, 315, 317 shrinkable film
307, 308 laminate film
314 first take-up part
316 second take-up part
319 third take-up part
400 liquid crystal display apparatus

### BEST MODE FOR CARRYING OUT THE INVENTION

In the specification of the present invention, in-plane refractive indices in a slow axis direction and a fast axis direction are respectively defined as nx and ny, and a thickness direction refractive index is defined as nz. The slow axis direction refers to a direction in which an in-plane refractive index becomes maximum.

In the specification of the present invention, for example, ny=nz includes not only a case where ny and nz are exactly the same, but also a case where ny and nz are substantially same.

The phrase “substantially perpendicular” in the specification of the present invention includes the case where an angle formed by two axes (for example, an absorption axis of a polarizer and an absorption axis of another polarizer) is 90°±2.0°, preferably 90 °±1.0°, and more preferably 90°±0.5°.

The phrase “substantially parallel” in the specification of the present invention includes the case where an angle formed by two axes (for example, a slow axis of a retardation film and an absorption axis of a polarizer) is 0°±2.0°, preferably 0°±1.0°, and more preferably 0°±0.5°.

### A. Outline of Entire Liquid Crystal Panel

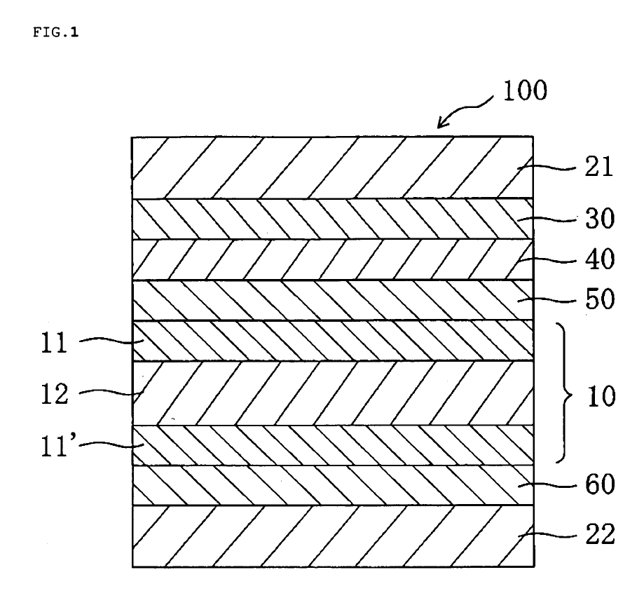

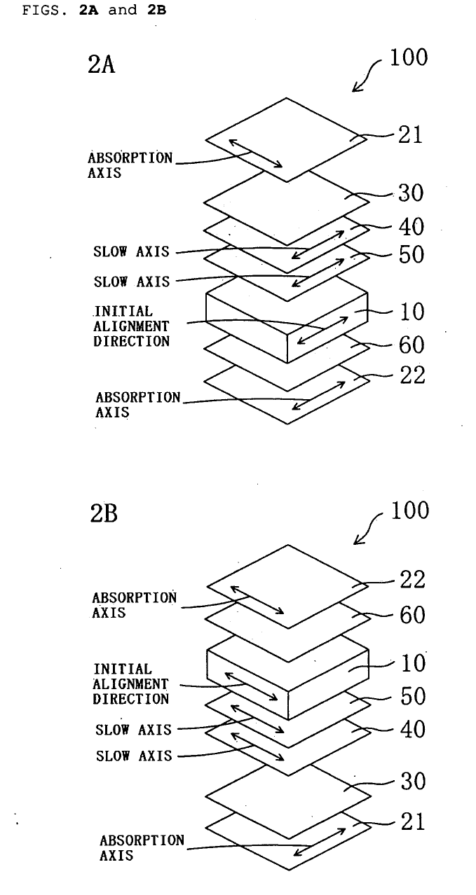

FIG. 1 is a schematic sectional view of a liquid crystal panel according to a preferred embodiment of the present invention. FIG. 2A is a schematic perspective view of the liquid crystal panel employing O-mode, and FIG. 2B is a schematic perspective view of the liquid crystal panel employing E-mode. Note that, a ratio among length, width, and thickness of each member in FIGS. 1, 2A, and 2B is different from that of an actual member for clarity. A liquid crystal panel 100 includes a liquid crystal cell 10 having a liquid crystal layer containing liquid crystal molecules homogeneously aligned in the absence of an electric field, a first polarizer 21 arranged on one side (a viewer side in FIG. 2A) of the liquid crystal cell 10, a second polarizer 22 arranged on the other side (a backlight side in FIG. 2A) of the liquid crystal cell 10, and an optical element (C) 30, an optical element (A) 40, and an optical element (B) 50, arranged between the first polarizer 21 and the liquid crystal cell 10, and an optical element (D) 60, arranged between the second polarizer 22 and the liquid crystal cell 10. Note that, practically, any suitable protective layers (not shown) can be arranged on outer sides of the first polarizer 21 and the second polarizer 22. Note that, preferably, an absorption axis of the first polarizer 21 and an absorption axis of the second polarizer 22 are substantially perpendicular to each other. In addition, the absorption axis of the first polarizer 21 and the slow axis of the optical element (A) 40 are preferably substantially perpendicular to each other. In addition, the absorption axis of the first polarizer 21 and the slow axis of the optical element (B) 50 are preferably substantially perpendicular to each other. It should be noted that the liquid crystal panel is not necessarily needed to include the optical element (C) 30 or the optical element (D) 60.

The optical element (A) 40 exhibits a refractive index ellipsoid of nx>nz>ny, is formed of one or more kinds of polycyclic compounds each having a —SO₃M group and/or a —COOM group (M represents a counter ion), and has an Nz coefficient of 0.05 to 0.45. The optical element (B) 50 exhibits a refractive index ellipsoid of nx>nz>ny and has an Nz coefficient of 0.55 to 0.95. The optical element (C) 30 preferably has substantially optical isotropy. The optical element (D) 60 preferably has substantially optical isotropy. By laminating such particular optical elements respectively on a liquid crystal cell, very satisfactory optical compensation is conducted, and consequently, a liquid crystal display apparatus with a high contrast in an oblique direction of the liquid crystal display apparatus and a small color shift amount in the oblique direction can be realized.

Preferably, the second polarizer 22 is arranged so that an absorption axis thereof is substantially parallel to an initial alignment direction of the liquid crystal cell 10. The first polarizer 21 is arranged so that an absorption axis thereof is substantially perpendicular to the initial alignment direction of the liquid crystal cell 10.

The liquid crystal panel of the present invention may be of so-called O-mode or so-called E-mode. The term “liquid crystal panel of O-mode” refers to a liquid crystal panel in which an absorption axis of a polarizer arranged on a backlight side of a liquid crystal cell and an initial alignment direction of the liquid crystal cell are parallel to each other. The term “liquid crystal panel of E-mode” refers to a liquid crystal panel in which an absorption axis of a polarizer arranged on a backlight side of a liquid crystal cell and the initial alignment direction of the liquid crystal cell are perpendicular to each other. In the case of the liquid crystal panel of O-mode, as shown in FIG. 2A, the first polarizer 21, the optical element (C) 30, the optical element (A) 40, and the optical element (B) 50 are preferably arranged on the viewer side of the liquid crystal cell 10, and the optical element (D) 60 and the second polarizer 22 are preferably arranged on the backlight side of the liquid crystal cell 10. In the case of the liquid crystal panel of E-mode, as shown in FIG. 2B, the first polarizer 21, the optical element (C) 30, the optical element (A) 40, and the optical element (B) 50 are preferably arranged on the backlight side of the liquid crystal cell 10, and the optical element (D) 60 and the second polarizer 22 are preferably arranged on the viewer side of the liquid crystal cell 10. In the present invention, such O-mode as shown in FIG. 2A is preferred. This is because better optical compensation is realized with the O-mode arrangement than with the E-mode arrangement. To be more specific, in the O-mode arrangement, the optical element (A) including a retardation film is arranged on a farther side from the backlight, so a liquid crystal display apparatus which: is unlikely to be adversely influenced by the heat of the backlight; and has small display unevenness can be obtained. It should be noted that the liquid crystal panel is not necessarily needed to include the optical element (C) 30 or the optical element (D) 60.

The liquid crystal panel of the present invention is not limited to the above embodiment, and for example, other constituent members (for example, an optical pressure-sensitive adhesive with isotropy and an isotropic film) may be arranged between respective constituent members shown in FIG. 1. Hereinafter, the constituent members of the liquid crystal panel of the present invention will be described in detail.

### B. Liquid Crystal Cell

Referring to FIG. 1, the liquid crystal cell 10 used in the present invention is provided with a pair of substrates 11 and 11′ and a liquid crystal layer 12 as a display medium interposed between the substrates 11 and 11′. One substrate (active matrix substrate) 11′ is provided with a switching element (typically TFT) for controlling electrooptic properties of liquid crystals, a scanning line for providing a gate signal to the switching element and a signal line for providing a source signal thereto (all not shown). The other substrate (color filter substrate) 11 is provided with color filters (not shown) and black matrix (not shown). The color filters may be provided on the active matrix substrate 11′ side as well. A distance (cell gap) between the substrates 11 and 11′ is controlled by a spacer (not shown). An alignment film (not shown) formed of, for example, polyimide is provided on a side of each of the substrates 11 and 11′, which is in contact with the liquid crystal layer 12.

The above liquid crystal layer 12 preferably includes a liquid crystal layer containing liquid crystal molecules aligned homogeneously in the absence of an electric field. The liquid crystal layer (eventually, the liquid crystal cell) typically exhibits a refractive index profile of nx>ny=nz.

The phrase “initial alignment direction of the liquid crystal cell” refers to a direction providing a maximum in-plane refractive index of the liquid crystal layer by alignment of the liquid crystal molecules in the liquid crystal layer in the absence of an electric field. Typical examples of drive mode using the liquid crystal layer exhibiting such refractive index profile include in-plane switching (IPS) mode, fringe field switching (FFS) mode, and ferroelectric liquid crystal (FLC) mode. Specific examples of liquid crystals used for those drive modes include nematic liquid crystals and smectic liquid crystals. For example, the nematic liquid crystals are used for the IPS mode and the FFS mode, and the smectic liquid crystals are used for the FLC mode.

In the above IPS mode, homogeneously aligned liquid crystal molecules in the absence of an electric field respond in such an electric field as parallel to substrates generated between a counter electrode and a pixel electrode each formed of metal (also referred to as a horizontal electric field) by utilizing an electrically controlled birefringence (ECB) effect. To be more specific, as described in “Monthly Display July” (p. 83 to p. 88, published by Techno Times Co., Ltd., 1997) or “Ekisho vol. 2, No. 4” (p. 303 to p. 316, published by Japanese Liquid Crystal Society, 1998), a normally black mode provides completely black display in the absence of an electric field by: adjusting an alignment direction of the liquid crystal cell without application of an electric field, to a direction of an absorption axis of one polarizer; and arranging polarizing plates above and below the liquid crystal cell to be perpendicular to each other. Under application of an electric field, liquid crystal molecules rotate while remaining parallel to substrates, to thereby obtain a transmittance in accordance with a rotation angle. Note that the IPS mode includes super in-plane switching (S-IPS) mode and advanced super in-plane switching (AS-IPS) mode each employing a V-shaped electrode, a zigzag electrode, or the like. Examples of a commercially available liquid crystal display apparatus of such IPS mode include: 20V-type wide liquid crystal television “Wooo” (trade name, manufactured by Hitachi, Ltd.); 19-type liquid crystal display “ProLite E481S-1” (trade name, manufactured by Iiyama Corporation); and 17-type TFT liquid crystal display “FlexScan L565” (trade name, manufactured by Eizo Nanao Corporation).

In the above FFS mode, homogeneously aligned liquid crystal molecules in the absence of an electric field respond in such an electric field as parallel to substrates generated between a counter electrode and a pixel electrode each formed of transparent conductor (also referred to as a horizontal electric field) by utilizing an electrically controlled birefringence effect. Note that the horizontal electric field in the FFS mode is also referred to as fringe electric field, which can be generated by setting a distance between the counter electrode and the pixel electrode each formed of transparent conductor narrower than a cell gap. To be more specific, as described in “Society for Information Display (SID) 2001 Digest” (p. 484 to p. 487) or JP 2002-031812 A, a normally black mode provides completely black display in the absence of an electric field by: adjusting an alignment direction of the liquid crystal cell without application of an electric field, to a direction of an absorption axis of one polarizer; and arranging polarizing plates above and below the liquid crystal cell to be perpendicular to each other. Under application of an electric field, liquid crystal molecules rotate while remaining parallel to substrates, to thereby obtain a transmittance in accordance with a rotation angle. Note that the above FFS mode includes advanced fringe field switching (A-FFS) mode and ultra fringe field switching (U-FFS) mode each employing a V-shaped electrode, a zigzag electrode, or the like. An example of a commercially available liquid crystal display apparatus of such FFS mode includes Tablet PC “M1400” (trade name, manufactured by Motion Computing, Inc.).

The above FLC mode utilizes property of ferromagnetic chiral smectic liquid crystals encapsulated between electrode substrates each having a thickness of about 1 to 2 μm to exhibit two stable states of molecular alignment, for example. To be more specific, the above ferroelectric chiral smectic liquid crystal molecules rotate within a plane parallel to the substrates and respond due to application of a voltage. The FLC mode can provide black and white displays based on the same principle as that of the above IPS mode or the above FFS mode. Further, the above FLC mode has such a feature in that a response speed is high compared with those in other drive modes. Note that, in the specification of the present invention, the above FLC mode includes surface stabilized ferroelectric liquid crystal (SS-FLC) mode, antiferroelectric liquid crystal (AFLC) mode, polymer stabilized ferroelectric liquid crystal (PS-FLC) mode, and V-shaped switching ferroelectric liquid crystal (V-FLC) mode.

The above homogeneously aligned liquid crystal molecules are obtained, as a result of interaction between substrates subjected to alignment treatment and the liquid crystal molecules, when alignment vectors of the above liquid crystal molecules are parallel to a substrate plane and uniformly aligned. Note that, in the specification of the present invention, homogenous alignment includes a case where the above alignment vectors are slightly tilted with respect to the substrate plane, that is, a case where the above liquid crystal molecules are pretilted. In a case where the liquid crystal molecules are pretilted, a pretilt angle is preferably 20° or less for maintaining a large contrast ratio and obtaining favorable display characteristics.

Any suitable nematic liquid crystals may be employed as the above nematic liquid crystals depending on the purpose. For example, the nematic liquid crystals may have positive dielectric anisotropy or negative dielectric anisotropy. A specific example of the nematic liquid crystals having positive dielectric anisotropy includes “ZLI-4535” (trade name, manufactured by Merck Ltd.). A specific example of the nematic liquid crystals having negative dielectric anisotropy includes “ZLI-2806” (trade name, manufactured by Merck Ltd.). Further, a difference between an ordinary refractive index (no) and an extraordinary refractive index (ne), that is, a birefringent index (Δn_{LC}) of the above nematic liquid crystals can be appropriately selected in accordance with the response speed, transmittance, and the like of the above liquid crystals. However, the birefringence index is preferably 0.05 to 0.30, in general.

Any suitable smectic liquid crystals may be employed as the above smectic liquid crystals depending on the purpose. The smectic liquid crystals to be used preferably have an asymmetric carbon atom in a part of a molecular structure and exhibit ferroelectric property (also referred to as ferroelectric liquid crystals). Specific examples of the smectic liquid crystals exhibiting ferroelectric property include p-decyloxybenzylidene-p′-amino-2-methylbutylcinnamate, p-hexyloxybenzylidene-p′-amino-2-chloropropylcinnamate, and 4-o-(2-methyl)butylresorcylidene-4′-octylaniline. Further, examples of commercially available ferroelectric liquid crystals include ZLI-5014-000 (trade name, capacitance of 2.88 nF, spontaneous polarization of −2.8 C/cm², manufactured by Merck Ltd.), ZLI-5014-100 (trade name, capacitance of 3.19 nF, spontaneous polarization of −20.0 C/cm², manufactured by Merck Ltd.), and (trade name, capacitance of 2.26 nF, spontaneous polarization of −9.6 C/cm², manufactured by Hoechst Aktiengesellschaft).

Any suitable cell gap may be employed as the cell gap (distance between substrates) of the above liquid crystal cell depending on the purpose. However, the cell gap is preferably 1.0 to 7.0 μm. A cell gap within the above range can reduce response time and provide favorable display characteristics.

### C. Polarizer

In the specification of the present invention, the term “polarizer” refers to an optical film capable of converting natural light or polarized light into any polarized light. Any suitable polarizer may be employed as a polarizer used in polarizing plate of the present invention. Preferably, a film capable of converting natural light or polarized light into linearly polarized light is used.

The above polarizer may have any suitable thickness. The thickness of the polarizer is typically 5 to 80 μm, preferably 10 to 50 μm, and more preferably 20 to 40 μm. A thickness of the polarizer within the above ranges can provide excellent optical properties and mechanical strength.

### C-1. Optical Characteristics of Polarizer

A transmittance (also referred to as single axis transmittance) of the above polarizer measured by using a light having a wavelength of 440 nm at 23° C. is preferably 41% or more, and more preferably 43% or more. Note that a theoretical upper limit of the single axis transmittance is 50%. A polarization degree is preferably 99.8 to 100%, and more preferably 99.9 to 100%. A transmittance and a polarization degree within the above ranges can further increase a contrast ratio in a front direction of a liquid crystal display apparatus employing the polarizer of the present invention.

The above single axis transmittance and the polarization degree can be measured by using a spectrophotometer “DOT-3” (trade name, manufactured by Murakami Color Research Laboratory). The above polarization degree can be determined by measuring a parallel transmittance (H₀) and a perpendicular transmittance (H₉₀) of the polarizer and using the following equation. Polarization degree (%)={(H₀−H₉₀)/(H₀+H₉₀)}^{1/2}×100. The above parallel transmittance (H₀) refers to a transmittance of a parallel laminate polarizer produced by piling two identical polarizers such that respective absorption axes of those are parallel to each other. Further, the above perpendicular transmittance (H₉₀) refers to a transmittance of a perpendicular laminate polarizer produced by piling two identical polarizers such that respective absorption axes thereof are perpendicular to each other. Note that the transmittance refers to a Y value obtained through color correction by a two-degree field of view (C source) in accordance with JIS Z8701-1982.

### C-2. Arrangement Method of Polarizer

Referring to FIGS. 1, 2A, and 2B, any suitable method may be employed as a method of arranging the first polarizer 21 and the second polarizer 22 depending on the purpose. When the optical element (C) 30 and the optical element (D) 60 are provided, the above first polarizer 21 and the second polarizer 22 are each preferably provided with an adhesive layer or a pressure-sensitive adhesive layer (both not shown) on a surface oppose to the liquid crystal cell. Then, the first polarizer 21 is bonded to the surface of the optical element (C) 30, and the second polarizer 22 is bonded to a surface of the optical element (D) 60. In this way, contrast of a liquid crystal display apparatus employing the polarizers can be enhanced.

A thickness of the adhesive or pressure-sensitive adhesive may be appropriately determined in accordance with intended use, adhesive strength, and the like. The adhesive has a preferable thickness of generally 0.1 to 50 μm. The pressure-sensitive adhesive has a preferable thickness of generally 1 to 100 μm.

Any suitable adhesive or pressure-sensitive adhesive may be employed for forming the above adhesive layer or pressure-sensitive adhesive layer in accordance with the kind of adherend. In particular, in a case where a film containing a polyvinyl alcohol-based resin as a main component is used for the polarizer, an aqueous adhesive is preferably used as the adhesive.

The above first polarizer 21 is preferably arranged such that its absorption axis is substantially perpendicular to an absorption axis of the opposing second polarizer 22. With an increase in deviation from the above angle relationship of “substantially perpendicular”, a contrast tends to decrease when used in a liquid crystal display apparatus.

### C-3. Optical Film Used in the Polarizer

The above polarizer is formed of a stretched polymer film containing as a main component a polyvinyl alcohol-based resin, which contains a dichromatic substance, for example. The polymer film containing as a main component the above polyvinyl alcohol-based resin is produced through a method described in [Example 1] of JP 2000-315144 A, for example.

The above polyvinyl alcohol-based resin to be used may be prepared by: polymerizing a vinyl ester-based monomer to obtain a vinyl ester-based polymer; and saponifying the resultant vinyl ester-based polymer to convert a vinyl ester unit into a vinyl alcohol unit. Examples of the above vinyl ester-based monomer include vinyl formate, vinyl acetate, vinyl propionate, vinyl valerate, vinyl laurate, vinyl stearate, vinyl benzoate, vinyl pivalate, and vinyl versatate. Of those, vinyl acetate is preferred.

The above polyvinyl alcohol-based resin may have any suitable average polymerization degree. The average polymerization degree is preferably 1,200 to 3,600, more preferably 1,600 to 3,200, and most preferably 1,800 to 3,000. Note that the average polymerization degree of the polyvinyl alcohol-based resin can be measured through a method in accordance with JIS K6726-1994.

A saponification degree of the above polyvinyl alcohol-based resin is preferably 90.0 to 99.9 mol % from a viewpoint of durability of the polarizer.

The above saponification degree refers to a ratio of units actually saponified into vinyl alcohol units to units which may be converted into vinyl alcohol units through saponification. Note that the saponification degree of the polyvinyl alcohol-based resin may be determined in accordance with JIS K6726-1994.

The polymer film containing as a main component a polyvinyl alcohol-based resin to be used in the present invention may preferably contain polyvalent alcohol as a plasticizer. Examples of the polyvalent alcohol include ethylene glycol, glycerin, propylene glycol, diethylene glycol, triethylene glycol, tetraethylene glycol, and trimethylolpropane. They may be used alone or in combination. In the present invention, ethylene glycol or glycerin is preferably used from the viewpoints of stretchability, transparency, thermal stability, and the like.

A use amount of the polyvalent alcohol in the present invention is preferably 1 to 30 (weight ratio) with respect to 100 of a total solid content in the polyvinyl alcohol-based resin. A use amount of the polyvalent alcohol within the above ranges can provide a polymer film having further improved coloring property, stretchability, and the like.

Any suitable dichromatic substance may be employed as the above dichromatic substance. Specific examples thereof include iodine and a dichromatic dye. In the specification of the present invention, the term “dichromatic” refers to optical anisotropy in which light absorption differs in two directions of an optical axis direction and a direction perpendicular thereto.

Examples of the above dichromatic dye include Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct First Orange S, and First Black.

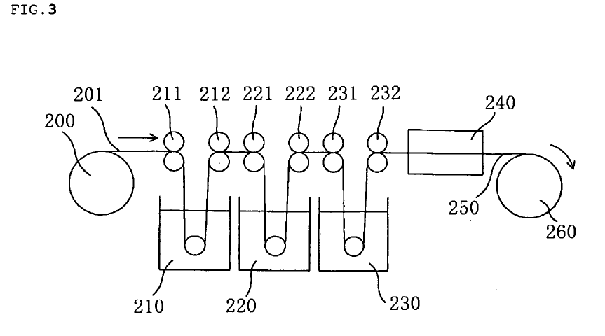

An example of a method of producing a polarizer will be described by referring to FIG. 3. FIG. 3 is a schematic diagram illustrating an overview of a typical production process of a polarizer used in the present invention. For example, a polymer film 201 containing as a main component a polyvinyl alcohol-based resin is fed from a delivery part 200, immersed in an aqueous iodine solution bath 210, and subjected to swelling and coloring treatment under tension in a longitudinal direction of the film by rollers 211 and 212 at different speed ratios. Next, the film is immersed in a bath 220 of an aqueous solution containing boric acid and potassium iodide, and subjected to crosslinking treatment under tension in a longitudinal direction of the film by rollers 221 and 222 at different speed ratios. The film subjected to crosslinking treatment is immersed in a bath 230 of an aqueous solution containing potassium iodide by rollers 231 and 232, and subjected to water washing treatment. The film subjected to water washing treatment is dried by drying means 240 to adjust its moisture content, and taken up in a winding part 260. The polymer film containing as a main component the above polyvinyl alcohol-based resin may be stretched to a 5 to 7 times length of the original length through the above process to produce the polarizer 250.

The above polarizer may have any suitable moisture content, but the moisture content is preferably 5% to 40%.

In addition, for example, a stretched film of a polymer film kneaded with a dichromatic substance, an O-type polarizer of a guest-host type (U.S. Pat. No. 5,523,863) obtained by aligning a liquid crystalline composition containing a dichromatic substance and a liquid crystalline compound in a certain direction, or an E-type polarizer (U.S. Pat. No. 6,049,428) obtained by aligning lyotropic liquid crystal in a certain direction as well as the above-mentioned polarizer can be used as a polarizer to be used in the present invention.

Note that in a case where polarizers are provided on both sides of a liquid crystal cell in the liquid crystal panel of the present invention, the polarizers may be the same or different from each other.

### D. Optical Element (A)

Referring to FIGS. 1 and 2, the optical element (A) 40 is arranged between the first polarizer 21 and the optical element (B) 50. When the liquid crystal panel of the present invention includes the optical element (C) 30 to be described later, the optical element (A) 40 is arranged between the optical element (C) 30 and the optical element (B) 50.

In the present invention, the above optical element (A) is used in combination with the optical element (B) to be described later (and, preferably, the optical element (C) to be described later) for reducing light leakage in an oblique direction of the liquid crystal panel. In general, light leakage is unlikely to occur in a front direction of a liquid crystal panel in which two polarizers are arranged on both sides of a liquid crystal cell so that their absorption axes are perpendicular to each other. However, light leakage occurs in an oblique direction of the panel, and, when the absorption axes of the respective polarizers are set at azimuths of 0° and 90°, a light leakage amount at an azimuth of 45° in the oblique direction tends to be maximum. Reducing the light leakage amount results in an increase in contrast ratio of the panel in the oblique direction, whereby the color shift amount of the panel in the oblique direction can be decreased.

### D-1. Optical Properties of Optical Element (A)

The optical element (A) to be used in the present invention exhibits a refractive index ellipsoid of nx>nz>ny.

An in-plane retardation Re[590] of the optical element (A) to be used in the present invention at a wavelength of 590 nm and 23° C. is preferably 100 nm to 400 nm, more preferably 150 nm to 350 nm, or still more preferably 200 nm to 300 nm.

Generally, the retardation value of the optical element (or the retardation film) may change depending upon the wavelength. This is referred to as the wavelength dispersion properties of the optical element (or the retardation film). In the specification of the present invention, the above wavelength dispersion properties can be obtained by a ratio: Re[480]/Re[590] of in-plane retardation values measured with light having wavelengths of 480 nm and 590 nm at 23° C.

Re[480]/Re[590] of the optical element (A) used in the present invention is preferably 0.8 to 1.2, more preferably 0.8 to 1.1, and particularly preferably 0.8 to 1.05. As the value is smaller in the above range, the retardation value becomes constant in a wider region of visible light. Therefore, in the case of using the optical element in a liquid crystal display apparatus, the deviation of a wavelength is unlikely to occur in leaking light, and the color shift amount in an oblique direction of the liquid crystal display apparatus can be further decreased.

The Rth[590] of the optical element (A) used in the present invention is preferably 30 nm to 130 nm, and more preferably 40 nm to 120 nm in a range satisfying 0<Rth[590]<Re[590]. The above Rth can be selected appropriately considering the ratio (which is also referred to as an Nz coefficient) between the thickness direction retardation value (Rth[590]) and the in-plane retardation value (Re[590]) described later.

In the specification of the present invention, the Rth[590]/Re[590] refers to a ratio (which is also referred to as an Nz coefficient) between the thickness direction retardation value Rth[590] and the in-plane retardation value Re[590] measured with light having a wavelength of 590 nm at 23° C.

The Nz coefficient of the above optical element (A) is preferably 0.05 to 0.45, more preferably 0.10 to 0.40, still more preferably 0.15 to 0.35, and particularly preferably 0.20 to 0.30.

### D-2. Means for Arranging Optical Element (A)

Referring to FIGS. 1, 2A, and 2B, when the optical element (C) 30 is provided to the liquid crystal panel of the present invention, as a method of arranging the above optical element (A) 40 between the optical element (C) 30 and the optical element (B) 50, any suitable method can be adopted depending upon the purpose. Preferably, a lyotropic liquid crystal aqueous solution forming the optical element (A) is applied to the surface of the optical element (C), whereby the optical element (A) is formed on the optical element (C). Thus, by forming the optical element (A) by coating, an optical element (A) with a very small thickness can be obtained.

Preferably, the above optical element (A) 40 is arranged so that a slow axis thereof is substantially perpendicular to an absorption axis of the first polarizer 21. As the degree to which the slow axis is not perpendicular to the absorption axis increases, the contrast tends to decrease when the optical element (A) 40 is used in a liquid crystal display apparatus.

### D-3. Configuration of Optical Element (A)

The configuration (lamination structure) of the optical element (A) is not particularly limited as long as the optical properties described in the above section D-1 are satisfied. Specifically, the optical element (A) may be a single layer or a plurality of layers. The detail of a material and the like for forming the optical element (A) will be described later in the section D-4.

The total thickness of the optical element (A) is preferably 0.05 to 10 μm, more preferably 0.1 to 5 μm, and still more preferably 0.2 to 3 μm. The optical element (A) in the present invention is obtained as a layer (coating layer) formed by coating, so the optical element (A) can have a very small thickness as described above. This can contribute to reduction of thickness of the liquid crystal display apparatus.

### D-4. Material Used in Optical Element (A)

The optical element (A) is formed of one or more kinds of polycylic compound having a —SO₃M group and/or a —COOM group (M represents a counter ion). The —SO₃M group represents a sulfonic acid group or a sulfonate group. The —COOM group represents a carboxylic acid group or a carboxylate group.

In the present invention, examples of the M include a hydrogen atom, an alkali metal atom, an alkaline-earth metal atom, a metal ion, or a substituted or unsubstituted ammonium ion. Examples of the above metal ion include Ni²⁺, Fe³⁺, Cu²⁺, Ag⁺, Zn²⁺, Al³⁺, Pd²⁺, Cd²⁺, Sn²⁺, Co²⁺, Mn²⁺, and Ce²⁺

The above polycyclic compound preferably exhibits a liquid crystal phase in a solution state (i.e., lyotropic liquid crystal). The above liquid crystal phase is preferably a nematic liquid crystal phase in terms of the excellent alignment property.

The above polycyclic compound is preferably an organic compound having two or more aromatic rings and/or heterocycles in a molecular structure, more preferably an organic compound having 3 to 8 aromatic rings and/or heterocycles in a molecular structure, and much more preferably an organic compound having 4 to 6 aromatic rings and/or heterocycles in a molecular structure. Particularly preferably, the above polycylic compound necessarily contains heterocycles in a molecular structure. Further, as a heteroatom in the heterocycle, any suitable heteroatom can be selected. The heteroatom is preferably a nitrogen atom.

The above polycyclic compound is preferably a compound represented by General Formula (1).

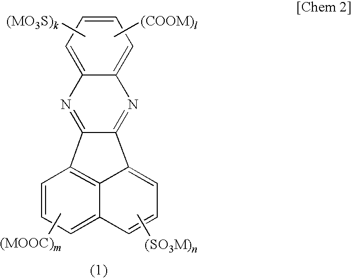

(in General Formula (1), M represents a counter ion, k and l respectively represent integers of 0 to 4 independently, the sum of k and l is an integer of 0 to 4, m and n respectively represent integers of 0 to 6 independently, the sum of m and n is an integer of 0 to 6, and k, l, m and n do not represent 0 at the same time.)

In the present invention, the polycyclic compound represented by General Formula (1), that is used for forming the optical element (A), is preferably k=0, 1=0, m=0, and n=1 to 2. Specifically, acenaphtho[1,2-b]quinoxaline-2-sulfonic acid, and acenaphtho[1,2-b]quinoxaline-2,5-disulfonic acid are preferred.

In order to obtain the optical element (A) in the present invention, preferably, when the liquid crystal panel of the present invention includes the optical element (C), a lyotropic liquid crystal aqueous solution containing both acenaphtho[1,2-b]quinoxaline-2-sulfonic acid, and acenaphtho[1,2-b]quinoxaline-2,5-disulfonic acid is applied to the surface of the optical element (C) to form the optical element (A).

Acenaphtho[1,2-b]quinoxaline derivative represented by General Formula (1) can be obtained by sulfonating an acenaphtho[1,2-b]quinoxaline compound with sulfuric acid, fuming sulfuric acid, or chlorosulfonic acid, as represented by General Formula (2).

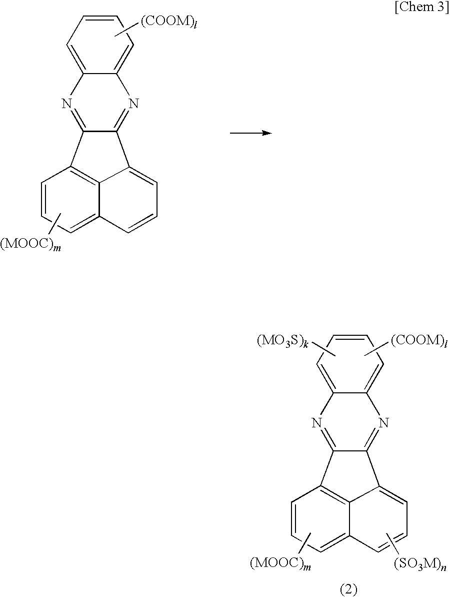

(in General Formula (2), M represents a counter ion, k and l respectively represent integers of 0 to 4 independently, the sum of k and l is an integer of 0 to 4, m and n respectively represent integers of 0 to 6 independently, the sum of m and n is an integer of 0 to 6, and k, l, m and n do not represent 0 at the same time.)

The acenaphtho[1,2-b]quinoxaline derivative represented by General Formula (1) can also be obtained by the condensation reaction between a benzene-1,2-diamine compound and an acenaphthoquinone compound, as represented by General Formula (3).

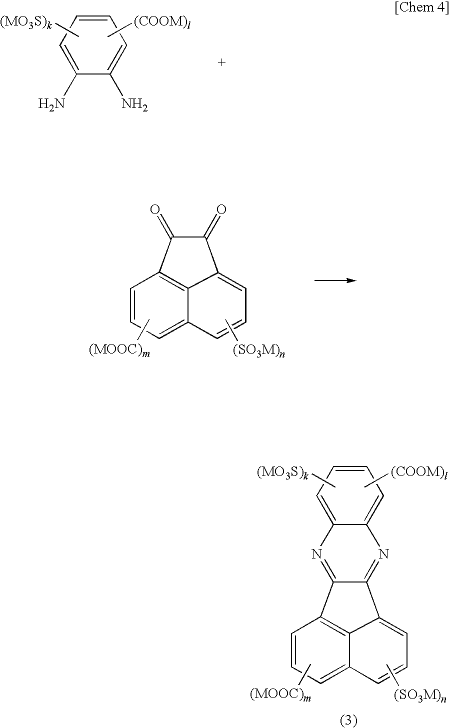

(in General Formula (3), M represents a counter ion, k and l respectively represent integers of 0 to 4 independently, the sum of k and l is an integer of 0 to 4, m and n respectively represent integers of 0 to 6 independently, the sum of m and n is an integer of 0 to 6, and k, l, m and n do not represent 0 at the same time.)

### D-5. Formation of Optical Element (A)

The optical element (A) of the present invention can be formed by any suitable method. Preferably, the second optical element is produced by a method including the following steps (1) to (3).

(1) The step of preparing a solution exhibiting a nematic liquid crystal phase, containing one or more kinds of polycyclic compound having a —SO₃M group and/or a —COOM group (M represents a counter ion) and a solvent.

(2) The step of preparing a base material at least one surface of which is hydrophilized.

(3) The step of applying the solution prepared in the above step (1) onto the surface, which is hydrophilized, of the base material prepared in the above step (2), followed by drying.

According to the above method, a lamination film including at least the optical element (A) and the base material can be obtained. In the present invention, the optical element (C) may correspond to the above base material.

In the above step (1), the above solution is prepared, preferably, by dissolving two or more kinds of polycylic compounds having different substitution positions of a —SO₃M group and/or a —COOM group in a solvent. The number of kinds of the polycyclic compounds contained in the above solution is preferably 2 or more, more preferably 2 to 6, and particularly preferably 2 to 4, excluding a trance amount of compounds contained as impurities.

The above solvent is used for dissolving the above polycyclic compounds to allow a nematic liquid crystal phase to be expressed. As the above solvent, any suitable one can be selected. The above solvent may be, for example, an inorganic solvent such as water, or an organic solvent such as alcohols, ketones, ethers, esters, aliphatic and aromatic hydrocarbons, halogenated hydrocarbons, amides, and cellosolves. Examples of the above solvent include: n-butanol, 2-butanol, cyclohexanol, isopropyl alcohol, t-butyl alcohol, glycerine, ethylene glycol, acetone, methyl ethyl ketone, methyl isobutyl ketone, cyclohexanone, cyclopentanone, 2-pentanone, 2-hexanone, diethyl ether, tetrahydrofuran, dioxane, anisole, ethyl acetate, butyl acetate, methyl lactate, n-hexane, benzene, toluene, xylene, chloroform, dichloromethane, dichloroethane, dimethylformamide, dimethylacetamide, methyl cellosolve, ethyl cellosolve. These solvents may be used alone or as a mixture.

The above solvent is preferably water. The electrical conductivity of the above water is preferably 20 μS/cm or less, more preferably 0.001 μS/cm to 10 μS/cm, and particularly preferably 0.01 μS/cm to 5 μS/cm. The lower limit value of the electrical conductivity of the above water is 0 μS/cm. By setting the electrical conductivity of the water in the above range, an optical element (A) having a high in-plane birefringent index can be obtained.

The concentration of a polycyclic compound in the above solution can be appropriately prepared in a range exhibiting a nematic liquid crystal phase, depending upon the kind of a polycyclic compound to be used. The concentration of the polycyclic compound in the above solution is preferably 5% by weight to 40% by weight, more preferably 5% by weight to 35% by weight, and much more preferably 5% by weight to 30% by weight. By setting the concentration of the solution in the above range, the solution can form a stable liquid crystal state. The above nematic liquid crystal phase can be checked and identified based on the optical pattern of a liquid crystal phase observed with a polarization microscope.

The above solution can further contain any suitable additive. Examples of the above additive include a surfactant, a plasticizer, a thermal stabilizer, alight stabilizer, a lubricant, an antioxidant, a UV-absorber, a fire retardant, a colorant, an antistatic agent, a compatibilizing agent, a cross-linking agent, and a thickener. The adding amount of the above additive is preferably more than 0 and 10 or less parts by weight with respect to 100 parts by weight of the solution.

The above solution can further contain a surfactant. The surfactant is used for enhancing the wettability and application property of a polycylic compound with respect to the surface of a base material. The above surfactant is preferably a nonionic surfactant. The adding amount of the above surfactant is preferably more than 0 and 5 or less parts by weight with respect to 100 parts by weight of the solution.

The term “hydrophilization treatment” in the above step (2) refers to the treatment of decreasing the contact angle of water with respect to a base material. The above hydrophilization treatment is used for enhancing the wettability and application property of the surface of a base material to which a polycyclic compound is to be applied. The above hydrophilization treatment is the treatment of decreasing the contact angle of water at 23° C. with respect to a base material by preferably 10% or more, more preferably 15% to 80%, and much more preferably 20% to 70%, compared with that before the treatment. The decrease ratio (%) is obtained by an expression: {(Contact angle before treatment−Contact angle after treatment)/Contact angle before treatment}×100.

The above hydrophilization treatment is the treatment of decreasing the contact angle of water at 23° C. with respect to a base material by preferably 5° or more, more preferably 10° to 65°, and much more preferably 20° to 65°, compared with that before the treatment.

The above hydrophilization treatment is the treatment of setting the contact angle of water at 23° C. with respect to a base material to preferably 5° to 60°, more preferably 5° to 50°, and much more preferably 5° to 45°. By setting the contact angle of water with respect to a base material in the above range, an optical element (A) exhibiting a high in-plane birefringent index and having a small variation in thickness can be obtained.

As the above hydrophilization treatment, any suitable method can be adopted. The above hydrophilization treatment may be, for example, a dry treatment or wet treatment. These treatments may be used alone or in combination.

Examples of the dry treatment include: a discharge treatment such as a corona treatment, a plasma treatment, and a glow discharge treatment; and an ionization actinic rays treatment such as a frame treatment, an ozone treatment, a UV-ozone treatment, a UV-treatment, and an electronic line treatment.

Examples of the wet treatment include an ultrasonic treatment using a solvent such as water or acetone, an alkali treatment, and an anchor coat treatment.

The base material used in the present invention is used for uniformly flow-casting a solution containing the above polycylic compound and solvent. As the above base material, any suitable one can be selected. In the present invention, the optical element (C) preferably can correspond to the above base material.

The application speed of the solution in the above step (3) is preferably 50 mm/second or more, and more preferably 100 mm/second or more. By setting the application speed in the above range, a shear force suitable for aligning a polycyclic compound is applied to the solution used in the present invention, and an optical element (A) having a high in-plane birefringent index and a small variation in thickness can be obtained.

As a method of applying the above solution on the base material surface, any suitable application method employing a coater may be adopted. Examples of the above coater include a bar coater, a reverse roll coater, a positive rotation roll coater, a gravure coater, a knife coater, a rod coater, a slot die coater, a slot orifice coater, a curtain coater, a fountain coater, an air doctor coater, a kiss coater, a dip coater, a bead coater, a blade coater, a cast coater, a spray coater, a spin coater, an extrusion coater, and a hot melt coater. Of those, preferred examples of the coater used in the present invention include a bar coater, a reverse roll coater, a positive rotation roll coater, a gravure coater, a rod coater, a slot die coater, a slot orifice coater, a curtain coater, and a fountain coater. An application method employing the above coater can provide a very thin optical element (A) having a small variation in thickness.

Any suitable method may be adopted as the method of drying the above solution. Examples of the drying methods include: drying means such as an air-circulating thermostatic oven in which hot air or cool air circulates; a heater using microwaves, far infrared rays, or the like; a heated roller for temperature adjustment; a heat pipe roller; and a heated metal belt.

It is preferred that the temperature for drying the above solution be an isotropic phase transition temperature or lower of the above solution, and the solution is dried by raising the temperature from a low temperature to a high temperature gradually. The above drying temperature is preferably 10° C. to 80° C., and more preferably 20° C. to 60° C. If the drying temperature is in the above temperature range, an optical element (A) having a small variation in thickness can be obtained.

The time for drying the above solution may be appropriately selected depending upon the drying temperature and the kind of a solvent. In order to obtain a birefringent film having a small variation in thickness, the time for drying the above solution is preferably 1 minute to 30 minutes, and more preferably 1 minute to 10 minutes.

The optical element (A) of the present invention may be produced by further performing the following step (4) after the above steps (1) to (3).

(4) The step of bringing a solution containing at least one kind of compound salt selected from the group consisting of an aluminum salt, a barium salt, a lead salt, a chromium salt, a strontium salt, and a compound salt having two or more amino groups in molecules into contact with the film obtained in the above step (3).

In the present invention, the above step (4) is used for insolubilizing the optical element (A) or rendering it hardly soluble with respect to water. Examples of the above compound salt include aluminum chloride, barium chloride, lead chloride, chromium chloride, strontium chloride, 4,4′-tetramethyldiaminodiphenylmethane hydrochloride, 2,2′-dipyridyl hydrochloride, 4,4′-dipyridyl hydrochloride, melamine hydrochloride, and tetraminopyrimidine hydrochloride. With such a compound salt, an optical element (A) excellent in water resistance can be obtained.

The compound salt concentration of a solution containing the above compound salt is preferably 3% by weight to 40% by weight, and more preferably 5% by weight to 30% by weight. By bringing the optical element (A) into contact with a solution containing a compound salt with a concentration in the above range, the second optical element excellent in durability can be obtained.

As a method of bringing the optical element (A) obtained in the above step (3) into contact with a solution containing the above compound salt, for example, any method can be adopted, such as a method of applying a solution containing the above compound salt to the surface of the optical element (A) and a method of immersing the optical element (A) in a solution containing the above compound salt. In the case where these methods are adopted, it is preferred that the obtained optical element (A) be washed with water or any solvent, and the resultant optical element is further dried, whereby a laminate excellent in adhesiveness of the interface between the base material and the optical element (A) can be obtained.

### E. Optical Element (B)

Referring to FIGS. 1 and 2, the optical element (B) 50 is arranged between the optical element (A) 40 and the liquid crystal cell 10.

In the present invention, the above optical element (B) is used for reducing light leakage in an oblique direction of a liquid crystal panel, in combination with the above optical element (A) (preferably further with optical element (C)). Generally, in a liquid crystal panel in which two polarizers are arranged on both sides of a liquid crystal cell so that absorption axes are perpendicular to each other, light leakage is unlikely to occur in a front direction. However, light leakage occurs in an oblique direction, and in the case where the absorption axes of the respective polarizers are set to be 0° and 90°, the light leakage amount at an azimuth of 45° in the oblique direction tends to be maximum. By reducing the light leakage amount, the contrast ratio in the oblique direction can be enhanced to decrease a color shift amount in the oblique direction.

### E-1. Optical Properties of Optical Element (B)

The optical element (B) used in the present invention exhibits a refractive index ellipsoid of nx>nz>ny.

The in-plane retardation Re[590] of the optical element (B) used in the present invention at a wavelength of 590 nm and 23° C. is preferably 100 nm to 400 nm, more preferably 150 nm to 350 nm, and much more preferably 200 nm to 300 nm.

Generally, the retardation value of the optical element (or the retardation film) may change depending upon the wavelength. This is referred to as the wavelength dispersion properties of the optical element (or the retardation film). In the specification of the present invention, the above wavelength dispersion properties can be obtained by a ratio: Re[480]/Re[590] of retardation values in a plane measured with light having wavelengths of 480 nm and 590 nm at 23° C.

Re[480]/Re[590] of the optical element (B) used in the present invention is preferably 0.8 to 1.2, more preferably 0.8 to 1.1, and particularly preferably 0.8 to 1.05. As the value is smaller in the above range, the retardation value becomes constant in a wider region of visible light. Therefore, in the case of using the second optical element in a liquid crystal display apparatus, the deviation of a wavelength is unlikely to occur in leaking light, and the color shift amount in an oblique direction of the liquid crystal display apparatus can be further decreased.

The Rth[590] of the optical element (B) used in the present invention is preferably 30 nm to 130 nm, and more preferably 40 nm to 120 nm in a range satisfying 0<Rth[590]<Re[590]. The above Rth can be selected appropriately considering the ratio (which is also referred to as an Nz coefficient) between the thickness direction retardation value (Rth[590]) and the in-plane retardation value (Re[590]) described later.

In the specification of the present invention, the Rth[590]/Re[590] refers to a ratio (which is also referred to as an Nz coefficient) between the thickness direction retardation value Rth[590] and the in-plane retardation value Re[590] measured with light having a wavelength of 590 nm at 23° C.

The Nz coefficient of the above optical element (B) is preferably 0.55 to 0.95, more preferably 0.60 to 0.90, much more preferably 0.65 to 0.85, and particularly preferably 0.70 to 0.80.

### E-2. Means for Arranging Optical Element (B)

Referring to FIGS. 1, 2A, and 2B, as a method of arranging the above optical element (B) 50 between the optical element (A) 40 and the liquid crystal cell 10, any suitable method can be adopted depending upon the purpose.

Preferably, the above optical element (B) 50 is arranged so that a slow axis thereof is substantially perpendicular to an absorption axis of the first polarizer 21. As the degree to which the slow axis is not perpendicular to the absorption axis increases, the contrast tends to decrease when the optical element (B) 50 is used in a liquid crystal display apparatus.

### E-3. Configuration of Optical Element (B)

The configuration (lamination structure) of the optical element (B) is not particularly limited as long as the optical properties described in the above section E-1 are satisfied. Specifically, the optical element (B) may be a single layer or a plurality of layers. The detail of a material and the like for forming the optical element (B) will be described later in the section E-4.

The total thickness of the above optical element (B) is preferably 20 to 500 μm, more preferably 20 to 400 μm.

### E-4. Material to be Used in Optical Element (B)

The above optical element (B) can be formed of any appropriate material; a stretched film of a polymer film is a representative example of the material. A resin of which the polymer film is formed is preferably a norbornene-based resin or a polycarbonate-based resin.

The norbornene-based resin is a resin obtained by polymerizing a norbornene-based monomer as a polymerization unit. Examples of the norbornene-based monomer include: norbornene, alkyl- and/or alkylidene-substituted products thereof such as 5-methyl-2-norbornene, 5-dimethyl-2-norbornene, 5-ethyl-2-norbornene, 5-butyl-2-norbornene, and 5-ethylidene-2-norbornene, and substituted products thereof with a polar group such as halogen; dicyclopentadiene and 2,3-dihydrodicyclopentadiene; dimethanooctahydronaphthalene, alkyl- and/or alkylidene-substituted products thereof, and substituted products thereof with a polar group such as halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; a trimer and a tetramer of cyclopentadiene such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene. The norbornene-based resin may be a copolymer of a norbornene-based monomer and another monomer.

An aromatic polycarbonate is preferably used as the polycarbonate-based resin. Representative examples of the aromatic polycarbonate include those obtained by reacting carbonate precursor substances with aromatic diphenol compounds. Specific examples of the carbonate precursor substance include phosgene, diphenols such as bischloroformate, diphenylcarbonate, di-p-tolylcarbonate, phenyl-p-tolylcarbonate, di-p-chlorophenylcarbonate, and dinaphthylcarbonate. Of those, phosgene and diphenylcarboante are preferred. Specific examples of the aromatic diphenol compound include 2,2-bis(4-hydroxyphenyl)propane, 2,2-bis(4-hydroxy-3,5-dimethylphenyl)propane, bis(4-hydroxyphenyl)methane, 1,1-bis-(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, and 1,1-bis(4-hydroxyphenyl)-3,3,5-trimethylcyclohexane. They may be used alone or in combination. Preferably, 2,2-bis(4-hydroxyphenyl)propane, 1,1-bis(4-hydroxyphenyl)cyclohexane, and 1,1-bis(4-hydroxyphenyl)-3,3,5-trimethylcyclohexane are used. Particularly preferably, 2,2-bis(4-hydroxyphenyl)propane and 1,1-bis(4-hydroxyphenyl)-3,3,5-trimethylcyclohexane are used in combination.

The polymer film may contain any other appropriate thermoplastic resin. Examples of other thermoplastic resins include general purpose plastics such as a polyolefin resin, a polyvinyl chloride-based resin, a cellulose-based resin, a styrene-based resin, an acrylonitrile/butadiene/styrene-based resin, an acrylonitrile/styrene-based resin, polymethyl methacrylate, polyvinyl acetate, and a polyvinylidene chloride-based resin; general-purpose engineering plastics such as a polyamide-based resin, a polyacetal-based resin, a polycarbonate-based resin, a denatured polyphenylene ether-based resin, a polybutylene terephthalate-based resin, and a polyethylene terephthalate-based resin; and super engineering plastics such as a polyphenylene sulfide-based resin, a polysulfone-based resin, a polyether sulfone-based resin, a polyether ether ketone-based resin, a polyarylate-based resin, a liquid crystalline resin, a polyamide-imide-based resin, a polyimide-based resin, and a polytetrafluoroethylene-based resin.

### E-5. Formation of Optical Element (B)

The optical element (B) of the present invention can be formed by any appropriate method.

Any appropriate method can be adopted as a method of producing the above stretched film. A representative method involves: attaching a shrinkable film on one or both sides of the above polymer film; and stretching the resultant polymer film under heat. The shrinkable film is used for applying a shrinkage force in the direction perpendicular to the direction in which the polymer film is stretched at the time of the stretching under heat. A material to be used in the shrinkable film is, for example, polyester, polystyrene, polyethylene, polypropylene, polyvinyl chloride, or polyvinylidene chloride; a polypropylene film is preferably used because the film is excellent in shrinkage uniformity and heat resistance.

Any appropriate stretching method can be adopted as the stretching method as long as a tension in the direction in which the polymer film is stretched and a shrinkage force in the direction perpendicular to the stretching direction in the plane of the film can be applied. The temperature at which the polymer film is stretched is preferably equal to or higher than the glass transition temperature (Tg) of the polymer film because a stretched film to be obtained easily shows a uniform retardation value and hardly crystallizes (hardly becomes opaque). The stretching temperature falls within the range of more preferably Tg of the polymer film+1° C. to Tg+30° C., still more preferably Tg+2° C. to Tg+20° C., particularly preferably Tg+3° C. to Tg+15° C., or most preferably Tg+5° C. to Tg+10° C. Setting the stretching temperature within such range allows the polymer film to be uniformly stretched under heat. Further, the stretching temperature is preferably constant along the width direction of the film because a stretched film having such good optical uniformity that a fluctuation in retardation value is small can be produced.

A stretch ratio at the time of the above stretching can be set to any appropriate value; the stretch ratio is preferably 1.05 to 2.00, more preferably 1.10 to 1.50, particularly preferably 1.20 to 1.40, or most preferably 1.25 to 1.30. Setting the stretch ratio within such range can provide a stretched film having the following characteristics: the width of the film shrinks to a small extent, and the film is excellent in mechanical strength.

### F. Optical Element (C)

Referring to FIGS. 1, 2A, and 2B, the optical element (C) 30 can be arranged between the first polarizer 21 and the optical element (A) 40. According to such form, the optical element (C) functions as a protective layer for the polarizer on a cell side to prevent the degradation of the polarizer, whereby the display characteristics of the liquid crystal display apparatus can be maintained at high levels over a long time period. The optical element (C) 30 preferably has substantially optical isotropy. The phrase “has substantially optical isotropy” as used in the specification of the present invention refers to the case where a refractive index profile satisfies nx=ny=nz where nx and ny represent in-plane principal refractive indices, and nz represents a thickness direction refractive index. It should be noted that the phrase “has substantially optical isotropy” as used in the specification of the present invention comprehends not only the case where nx, ny, and nz are exactly identical to one another but also the case where nx, ny, and nz are substantially identical to one another (nx≈ny≈nz). Here, the phrase “the case where nx, ny, and nz are substantially identical to one another” comprehends, for example, the case where the in-plane retardation value (Re[590]) of the optical element is 10 nm or less and the absolute value of the thickness direction retardation value (Rth[590]) of the optical element is 10 nm or less.

In the case where the liquid crystal panel of the present invention includes the above optical element, the optical element (C) is used for eliminating the adverse influence exerted on the display characteristics of the liquid crystal display apparatus. Generally, a liquid crystal layer (consequently, a liquid crystal cell) containing liquid crystal molecules aligned homogeneously has a retardation comparable to the product of a cell gap and a birefringent index of a liquid crystal layer. The retardation of the liquid crystal layer may synergistically function with the retardation of the optical element (C) to adversely influence the display characteristics of the liquid crystal display apparatus greatly. Specifically, in the case where the absolute value of the thickness direction retardation value of the above optical element (C) exceeds 10 nm, the light leakage of the liquid crystal display apparatus occurs, the contrast ratio in an oblique direction decreases, and the color shift amount in the oblique direction tends to increase. By decreasing the in-plane and thickness direction retardation values of the optical element (C), the adverse influence exerted on the display characteristics of the liquid crystal display apparatus by the retardation of the above liquid crystal layer can be eliminated. Consequently, the optical compensation obtained by the combination of the first optical element and the second optical element is exhibited sufficiently, and a liquid crystal display apparatus having satisfactory display characteristics can be obtained.

### F-1. Optical Properties of Optical Element (C)

The Re[590] of the optical element (C) that can be used in the present invention is preferably as small as possible. The Re[590] is preferably 5 nm or less, and more preferably 3 nm or less. If the Re[590] is in the above range, the contrast ratio in the oblique direction of the liquid crystal display apparatus is enhanced, and the color shift amount in the oblique direction can be decreased.

The Rth[590] of the above optical element (C) is also preferably as small as possible. The absolute value of the Rth[590] is preferably 10 nm or less, more preferably 7 nm or less, and further more preferably 5 nm or less. By setting the absolute value of the Rth[590] in the above range, the adverse influence caused by Rth, exerted on the display characteristics of the liquid crystal display apparatus, can be eliminated, and the contrast ratio in the oblique direction of the liquid crystal display apparatus is enhanced and the color shift amount in the oblique direction can be decreased.

### F-2. Means for Arranging Optical Element (C)

Referring to FIGS. 2A and 2B, as a method of arranging an optical element (C) 30 between the first polarizer 21 and the optical element (A) 40, any suitable method can be adopted depending upon the purpose. Preferably, adhesive layers or pressure-sensitive adhesive layers (not shown) are provided on both sides of the above optical element (C) 30, and the optical element (C) 30 is attached to the first polarizer 21 and the optical element (A) 40. By filling the gap between the respective optical elements with an adhesive layer or a pressure-sensitive adhesive layer, the relationship between the optical axes of the respective optical elements can be prevented from being lost and the respective optical elements can be prevented from rubbing against each other to damage them when the optical elements are incorporated in a liquid crystal display apparatus. Further, the interface reflection between the layers of the respective optical elements is reduced, whereby the contrast ratio in a front direction and an oblique direction can be enhanced when they are used in a liquid crystal display apparatus.

The thickness of the above adhesive layer or pressure-sensitive adhesive layer can be determined appropriately in a suitable range depending upon the use, the adhesive strength, and the like. The preferred thickness range of the adhesive is preferably 0.1 to 50 μm. The preferred thickness range of the pressure-sensitive adhesive is preferably 1 to 100 μm.

As an adhesive or pressure-sensitive adhesive forming the above adhesive layer or pressure-sensitive adhesive layer, any suitable adhesive or pressure-sensitive adhesive can be adopted. Examples of the adhesive include a thermoplastic adhesive, a hot-melt adhesive, a rubber-based adhesive, a thermosetting adhesive, a monomer reactive adhesive, an inorganic adhesive, and a natural adhesive. Examples of the pressure-sensitive adhesive include a solvent-type pressure-sensitive adhesive, a non-aqueous emulsion-type pressure-sensitive adhesive, an aqueous pressure-sensitive adhesive, a hot-melt pressure-sensitive adhesive, a liquid curable pressure-sensitive adhesive, a curable pressure-sensitive adhesive, and a pressure-sensitive adhesive by calendaring.

In the above optical element (C) 30, in the case where nx and ny are exactly the same, a retardation value is not caused in a plane, so a slow axis is not detected, and the optical element (C) 30 can be arranged irrespective of the absorption axis of the first polarizer 21 and the slow axis of the optical element (A) 40. Even when nx and ny are substantially the same, in the case where nx and ny are slightly different from each other, a slow axis may be detected. In this case, preferably, the above optical element (C) 30 is arranged so that the slow axis thereof is substantially parallel or perpendicular to the absorption axis of the first polarizer 21. As the degree at which the slow axis of the optical element (C) 30 is not perpendicular or parallel to the absorption axis of the first polarizer 21 increases, a contrast tends to decrease when the optical element (C) 30 is used in a liquid crystal display apparatus.

### F-3. Configuration of Optical Element (C)

The configuration (lamination structure) of the optical element (C) is not particularly limited, as long as the optical properties described in the above section F-1 are satisfied. The above optical element (C) may be a single optical film, or a laminate composed of two or more optical films. In the case where the optical element (C) is a laminate, the optical element (C) may include an adhesive layer or a pressure-sensitive adhesive layer for attaching the above optical film. As long as the optical element (C) has substantially optical isotropy, the above optical film may be an isotropic film or a retardation film. For example, in the case where two retardation films are laminated, the respective retardation films are preferably arranged so that slow axes thereof are perpendicular to each other. Due to such arrangement, an in-plane retardation value can be decreased. Further, it is preferred that, as the respective retardation films, films having positive and negative thickness direction retardation values be laminated. Due to such lamination, the thickness direction retardation value can be decreased.

The total thickness of the above optical element (C) is preferably 20 μm to 500 μm, more preferably 20 μm to 400 μm, and much more preferably 20 μm to 200 μm. Setting the total thickness in the above range can contribute to the reduction in thickness of the liquid crystal display apparatus.

### F-4. Optical Film Used in Optical Element (C)

An optical film used in an optical element (C) is preferably an isotropic film. In the specification of the present invention, the term “isotropic film” refers to a film having a small optical difference in a three-dimensional direction, and exhibiting substantially no anisotropic optical properties such as birefringence. Note that the phrase “exhibiting substantially no anisotropic optical properties” refers to that the case where the display characteristics of the liquid crystal display apparatus is not adversely influenced practically even though birefringence occurs slightly is included in the isotropic case. The isotropic film used in the optical element (C) is not particularly limited, and a film is preferably used which is excellent in transparency, mechanical strength, thermal stability, moisture blocking property, and the like, and in which optical unevenness is unlikely to be caused by distortion.

The thickness of the above isotropic film can be appropriately selected depending upon the purpose and the lamination structure of the optical element (C). The thickness of the above isotropic film is preferably 20 μm to 200 μm, more preferably 20 μm to 180 μm, and much more preferably 20 μm to 150 μm. If the thickness of the above isotropic film is in the above range, an optical film being excellent in mechanical strength and optical uniformity and satisfying the optical properties described in the above section F-1 can be obtained.

The absolute value (C[590](m²/N)) of the photoelastic coefficient of the above isotropic film is preferably 1×10⁻¹² to 100×10⁻¹², more preferably 1×10⁻¹² to 50×10⁻¹², much more preferably 1×10⁻¹² to 30×10⁻¹², and particularly preferably 1×10⁻¹² to 8×10⁻¹². As the absolute value of the photoelastic coefficient is smaller, when the isotropic film is used in a liquid crystal display apparatus, the displacement and unevenness of retardation values caused by the shrinkage stress of a polarizer and the heat of a backlight are unlikely to occur, whereby a liquid crystal display apparatus excellent in display uniformity can be obtained.

The transmittance of the above isotropic film measured with light having a wavelength of 590 nm at 23° C. is preferably 80% or more, more preferably 85% or more, and much more preferably 90% or more. It is preferred that the optical element (B) have a light transmittance similar to the above.

The above isotropic film is preferably a stretched film of a polymer film containing a thermoplastic resin as a main component. The thermoplastic resin may be an amorphous polymer or a crystalline polymer. The amorphous polymer has an advantage of being excellent in transparency, and the crystalline polymer has an advantage of being excellent in stiffness, strength, and drug resistance. In addition, the polymer film containing the thermoplastic resin as a main component may or may not be stretched.

Examples of the above thermoplastic resin include: general purpose plastics such as polyethylene, polypropylene, polynorbornene, polyvinyl chloride, a cellulose ester, polystyrene, an ABS resin, an AS resin, polymethylmethacrylate, polyvinyl acetate, and polyvinylidene chloride; general purpose engineering plastics such as polyamide, polyacetal, polycarbonate, modified polyphenylene ether, polybutylene terephthalate, and polyethylene terephthalate; and super engineering plastics such as polyphenylene sulfide, polysulfone, polyethersulfone, polyetheretherketone, polyarylate, a liquid crystalline polymer, polyamideimide, polyimide, and polytetrafluoroethylene. The above thermoplastic resin may be used alone or in combination. Further, the above thermoplastic resin may be used after any suitable polymer modification. Examples of the polymer modification include copolymerization, crosslinking, and modifications in molecular terminals and stereoregularity. A retardation film used in the first optical element is particularly preferably a polymer film containing as a main component a cellulose ester.

The isotropic film used in the optical element (C) is more preferably a polymer film containing, as a main component, at least one resin selected from a cellulose ester, a cycloolefin-based resin obtained by hydrogenating a ring-opening polymer of a norbornene-based monomer, an addition copolymer of a norbornene-based monomer and an α-olefin monomer, and an addition copolymer of a maleimide-based monomer and an olefin monomer.

As the above cellulose ester, any suitable cellulose ester can be adopted. Specific examples thereof include organic acid esters such as cellulose acetate, cellulose propionate, and cellulose butyrate. Further, the above cellulose ester may be a mixed organic acid ester in which hydroxy groups of cellulose are partly substituted with an acetyl group and a propionyl group, for example. A polymer film whose Re[590] and Rth[590] are both small, containing the above cellulose ester as a main component, is preferably formed by casting method, and the Re[590] and the Rth[590] can be appropriately adjusted by the forming conditions, the film thickness, and the like. The film can be obtained by, for example, the method described in Example 1 of JP 7-112446 A. Further, the film can also be obtained with the Rth[590] before treatment decreased by swelling a commercially available film with a ketone-based solvent such as cyclopentanone, followed by drying.

As the above cycloolefin-based resin obtained by hydrogenating a ring-opening polymer of a norbornene-based monomer, any suitable resin can be adopted. Examples of a polymer film containing, as a main component, the cycloolefin-based resin obtained by hydrogenating a ring-opening polymer of a norbornene-based monomer include “ZEONEX series” (480, 480R, etc.) (trade name) manufactured by Nippon Zeon Co., Ltd., “Zeonor series” (ZF14, ZF16, etc.) (trade name) manufactured by Nippon Zeon Co., Ltd., and “Arton series” (ARTON G, ARTON F, etc.) (trade name) manufactured by JSR Corporation. A polymer film whose Re[590] and Rth[590] are both small, containing, as a main component, the above cycloolefin-based resin obtained by hydrogenating a ring-opening polymer of a norbornene-based monomer is preferably formed by extrusion, and the Re[590] and the Rth[590] can be appropriately adjusted by the forming conditions, the film thickness, and the like. Specifically, the film can be obtained by, for example, the method described in Example 1 of JP 4-301415 A.

The above addition copolymer of a norbornene-based monomer and α-olefin monomer can be obtained by, for example, the method described in Example 1 of JP 61-292601 A.

As the norbornene-based monomer, tricyclo[4.3.1^{2,5}.0^{1,6}]-deca-3,7-diene (common name: dicyclopentadiene) and a derivative thereof can also be used. Specific examples thereof include tricyclo[4.3.1^{2,5}.0^{1,6}]-deca-3-ene, 2-methyl-tricyclo[4.3.1^{2,5}.0^{1,6}]-deca-3-ene, and 5-methyl-tricyclo[4.3.1^{2,5}.0^{1,6}]-deca-3-ene, and polar group (such as halogen)-substituted products thereof.

The norbornene-based monomers may be used alone, or two or more of them may be used in combination. The norbornene-based monomer may be used after having been subjected to any appropriate denaturation.

The norbornene-based monomer is preferably 5-methyl-bicyclo[2.2.1]-hept-2-ene, 5-methyl-bicyclo[2.2.1]-hept-2-ene, 5-methoxycarbonyl-bicyclo[2.2.1]-hept-2-ene, 5-methyl-5-methoxycarbonyl-bicyclo[2.2.1]-hept-2-ene, 5-phenyl-bicyclo[2.2.1]-hept-2-ene, tricyclo[4.3.1^{2,5}.0^{1,6}]-deca-3,7-diene, tricyclo[4.3.1^{2,5}.0^{1,6}]-deca-3-ene, tetracyclo[4.4.1^{2,5}.1^{7,10}.0]-dodeca-3-ene, 8-methyl-tetracyclo[4.4.1^{2,5}.1^{7,10}.0]-dodeca-3-ene, 8-methoxycarbonyl-tetracyclo[4.4.1^{2,5}.1^{7,10}.0]-dodeca-3-ene, or 8-methyl-8-methoxycarbonyltetracyclo[4.4.1^{2,5}.1^{7,10}.0]-dodeca-3-ene, or a combination thereof.

Examples of α-olefin monomers include α-olefin monomers preferably having 2 to 20 carbon atoms, or more preferably 2 to 10 carbon atoms. Preferable examples include ethylene, propylene, 1-butene, 3-methyl-1-butene, 1-pentene, 3-methyl-1-pentene, 4-methyl-1-pentene, 1-hexane, 1-octane, 1-decene, 1-dodecene, 1-tetradecene, 1-hexadecane, and 1-eicosene. Of those, ethylene is particularly preferable. The α-olefin may be used alone, or two or more of them may be used in combination. The α-olefins may be copolymerized with other vinyl-based monomers as required unless the object of the present invention is impaired.

An extrusion forming method is preferably used to obtain a polymer film containing an addition copolymer of the norborene-based monomer and α-olefin monomer as a main component, in which both the values of Re[590] and Rth[590] are small, where the values of Re[590] and Rth[590] can be appropriately adjusted by the forming conditions and the film thickness, and the like.

The addition copolymer of the maleimide-based monomer and olefin monomer used in the isotropic film may be obtained, for example, through a method described in Example 1 of Japanese Patent Application Laid-open No. Hei 5-59193.

Examples of the maleimide-based monomer include N-alkyl substituted maleimides such as N-methyl maleimide, N-ethyl maleimide, N-n-propylmaleimide, N-i-propylmaleimide, N-n-butylmaleimide, N-i-butylmaleimide, N-s-butylmaleimide, N-t-butylmaleimide, N-n-pentylmaleimide, N-n-hexylmaleimide, N-n-heptylmaleimide, N-n-octylmaleimide, N-laurylmaleimide, N-stearylmaleimide, N-cyclopropylmaleimide, N-cyclobutylmaleimide, and N-cyclohexylmaleimide. Of those, N-methyl maleimide, N-ethyl maleimide, N-i-propylmaleimide, and N-cyclohexylmaleimide are preferable. The maleimide-based monomer may be used alone, or two or more of them may be used in combination.

Examples of the olefin monomer include olefin monomers such as isobutene, 2-methyl-1-butene, 2-methyl-1-pentene, 2-methyl-1-hexene, 1-methyl-1-heptene, 1-isooctene, 2-methyl-1-octene, 2-ethyl-1-pentene, 2-methyl-2-butene, 2-methyl-2-pentene, and 2-methyl-2-hexene. Of those, isobutene is preferable. The olefin monomer may be used alone, or two or more of them may be used in combination.

Alternatively, the above addition copolymer of a maleimide-based monomer and an olefin monomer can be further copolymerized with any other vinyl-based monomer as required to such an extent that an object of the present invention is not impaired. A polymer film which contains the above addition copolymer of a maleimide-based monomer and an olefin monomer as a main component and the Re[590] and Rth[590] of which are both small is preferably formed by an extrusion forming method, and the Re[590] and the Rth[590] can be appropriately adjusted by conditions for the forming, the thickness of the film, and the like. The film can be obtained by, for example, the method described in Example 1 of Japanese Patent Application Laid-Open No. 2004-45893.

As the above isotropic polymer, in addition to the materials described above, there are given a polycarbonate-based resin having 9,9-bis(4-hydroxyphenyl)fluorene at a side chain described in JP 2001-253960 A, a random copolymer of a monomer constituting a polymer that exhibits positive alignment birefringence and a monomer constituting a polymer that exhibits negative alignment birefringence described on pages 194 to 207 of “Development and Application Technique of Optical Polymer Material” 2003, published by NTS Inc., and a polymer doped with an anisotropic low molecule or birefringent crystal.

### G. Optical Element (D)

Referring to FIGS. 1, 2A, and 2B, the optical element (D) 60 can be arranged between the liquid crystal cell 10 and the second polarizer 22. When the liquid crystal panel is of O-mode, as shown in FIG. 2A, the optical element (D) 60 can be arranged between the liquid crystal cell 10 and the second polarizer 22 arranged on the backlight side of the liquid crystal cell. When the liquid crystal panel is of E-mode, as shown in FIG. 2B, the optical element (D) 60 can be arranged between the liquid crystal cell 10 and the second polarizer 22 arranged on the viewer side of the liquid crystal cell. According to such form, the optical element (D) functions as a protective layer for the polarizer on a cell side to prevent the degradation of the polarizer, whereby the display characteristics of the liquid crystal display apparatus can be maintained at high levels over a long time period. The optical element (D) 60 has substantially optical isotropy.

In the present invention, the optical element (D) can be used for eliminating adverse influences on the display characteristics of the liquid crystal display apparatus. In general, a liquid crystal layer (consequently, a liquid crystal cell) containing liquid crystal molecules aligned homogeneously has a retardation comparable to the product of a cell gap and the birefringent index of the liquid crystal layer. The retardation of the liquid crystal layer may synergistically function with the retardation of the optical element (D) to exert remarkable adverse influences on the display characteristics of the liquid crystal display apparatus. To be specific, when the absolute value of the thickness direction retardation value of the above optical element (D) exceeds 10 nm, the following tendency is observed: light leakage from the liquid crystal display apparatus occurs, the contrast ratio of the apparatus in an oblique direction decreases, and the color shift amount of the apparatus in the oblique direction increases. Decreasing the in-plane and thickness direction retardation values of the optical element (D) can eliminate the adverse influences exerted on the display characteristics of the liquid crystal display apparatus by the retardation of the above liquid crystal layer. As a result, a liquid crystal display apparatus having good display characteristics can be obtained.

### G-1. Optical Properties of Optical Element (D)

The optical element (D) can exert optical properties identical to those of the optical element (C) described in the above section F-1.

### G-2. Means for Arranging Optical Element (D)

Referring to FIGS. 2A and 2B, any appropriate method can be adopted as a method of arranging the above optical element (D) 60 between the liquid crystal cell 10 and the second polarizer 22 depending on a purpose. A preferred method is as follows: an adhesive layer or pressure-sensitive adhesive layer (not shown) is provided on each of both sides of the above optical element (D) 60, and the optical element is bonded to the liquid crystal cell 10 and the second polarizer 22. Filling a gap between the respective optical elements with an adhesive layer or pressure-sensitive adhesive layer as described above can prevent a relationship between the optical axes of the respective optical elements from being lost, and can prevent the respective optical elements from rubbing against each other to damage them when the optical elements are incorporated into a liquid crystal display apparatus. In addition, interface reflection between the layers of the respective optical elements is reduced, whereby the contrast ratios of a liquid crystal display apparatus in a front direction and an oblique direction can be increased when the optical elements are used in the liquid crystal display apparatus.

The same range and the same kind as those described in the above section F-2 can be adopted as the thickness of the above adhesive layer or pressure-sensitive adhesive layer, and the kind of the adhesive or pressure-sensitive adhesive of which the adhesive layer or pressure-sensitive adhesive layer is formed.

In the optical element (D) 60, when nx and ny are exactly identical to each other, no retardation value arises in the plane of the element, so no slow axis is detected in the element, and the optical element can be arranged irrespective of the absorption axis of the second polarizer 22. Even when nx and ny are substantially identical to each other, a slow axis may be detected in the element as long as nx and ny are slightly different from each other. In this case, the above optical element (D) 60 is preferably arranged so that its slow axis is substantially parallel or perpendicular to the absorption axis of the second polarizer 22. As the extent to which the slow axis is not perpendicular or parallel to the absorption axis increases, the contrast of a liquid crystal display apparatus tends to decrease when the optical element is used in the liquid crystal display apparatus.

### G-3. Configuration of Optical Element (D)

The same configuration as that of the optical element (C) described in the above section F-3 can be adopted.

### G-4. Optical Film Used in Optical Element (D)

The same optical film as that used in the optical element (C) described in the above section F-4 can be adopted.

### H. Liquid Crystal Display Apparatus

The liquid crystal panel of the present invention may be used for: a liquid crystal display apparatus such as a personal computer, a liquid crystal television, a cellular phone, or a personal digital assistance (PDA); or an image display apparatus such as an organic electroluminescence display (organic EL), a projector, a projection television, or a plasma television. In particular, the liquid crystal panel of the present invention is preferably used for a liquid crystal display apparatus, and particularly preferably used for a liquid crystal television.

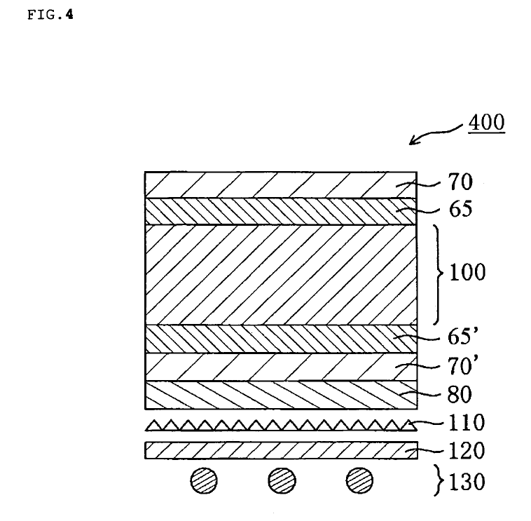

FIG. 4 is a schematic sectional view of a liquid crystal display apparatus according to a preferred embodiment of the present invention. A liquid crystal display apparatus 400 is provided with: a liquid crystal panel 100 of the present invention; protective layers 65 and 65′ arranged on both sides of the liquid crystal panel 100; surface treated layers 70 and 70′ arranged on outer sides of the protective layers 65 and 65′; a brightness enhancement film 80, a prism sheet 110, a light guide plate 120, and a lamp 130 arranged on an outer side (backlight side) of the surface treated layer 70′. Treated layers subjected to hard coat treatment, antireflection treatment, anti-sticking treatment, diffusion treatment (also referred to as anti-glare treatment), or the like are used as the above surface treated layers 70 and 70′. Further, a polarization separation film having a polarization selection layer “D-BEF series” (trade name, available from Sumitomo 3M Limited, for example) or the like is used as the above brightness enhancement film 80. Those optical members are used, to thereby obtain a display apparatus with better display characteristics. Further, according to another embodiment, the optical members shown in FIG. 4 may be partly omitted or replaced by other members in accordance with the drive mode or application of the liquid crystal cell to be used as long as the effects of the present invention are obtained.

### I. Intended Use of Liquid Crystal Panel of the Present Invention

The intended use of the liquid crystal panel and liquid crystal display apparatus of the present invention is not particularly limited, but the liquid crystal panel and the liquid crystal display apparatus of the present invention may be used for various purposes such as: office automation (OA) devices such as a personal computer monitor, a laptop personal computer, and a copying machine; portable devices such as a cellular phone, a watch, a digital camera, a personal digital assistance (PDA), and a portable game machine; domestic electric appliances such as a video camera, a liquid crystal television, and a microwave; in-car devices such as a back monitor, a car navigation system monitor, and a car audio; display devices such as a commercial information monitor; security devices such as a surveillance monitor; and nursing care/medical devices such as a nursing monitor and a medical monitor.

### EXAMPLES

The present invention will be described in more detail by using the following examples and comparative examples. Note that the present invention is not limited to the following examples. Note that analysis methods used in the examples are described below.

(1) Method of measuring a single axis transmittance and a polarization degree of a polarizer:

The single axis transmittance and the polarization degree were measured at 23° C. by using a spectrophotometer “DOT-3” (trade name, manufactured by Murakami Color Research Laboratory Co., Ltd.).

(2) Method of calculating thickness:

In a case where the thickness was less than 10 μm, the thickness was measured by using a spectrophotometer for thin film “Multi Channel Photo Detector MCPD-2000” (trade name, manufactured by Otsuka Electronics Co., Ltd.). In a case where the thickness was 10 μm or more, the thickness was measured by using a digital micrometer “KC-351C-type” (trade name, manufactured by Anritsu Corporation).

(3) Method of measuring retardation value (Re, Rth):

Retardation values were measured with light having a wavelength of 590 nm at 23° C., using a retardation meter “KOBRA21-ADH” (trade name, manufactured by Oji Scientific Instruments) with parallel Nicols as a principle. Note that, regarding the wavelength dispersion measurement, light having a wavelength of 480 nm was also used.

(4) Method of measuring the contact angle of water:

Liquid was dropped onto a base material, and the contact angle of water with respect to the base material after an elapse of 5 seconds was measured with a solid-liquid interface analyzer “Drop Master 300” (trade name, manufactured by Kyowa Interface Science Co., Ltd.). The measurement condition was a static contact angle measurement. As water, ultra-pure water was used, and the amount of liquid droplets was set to be 0.5 μl. An average of 10 repeated measurements was determined as a measurement value for each base material.

(5) Method of measuring electric conductivity:

After an electrode of a solution conductivity meter “CM-117” (trade name, manufactured by Kyoto Electronics Manufacturing Co., Ltd.) was washed with an aqueous solution prepared so as to have a concentration of 0.05% by weight, a container of 1 cm³ connected to the electrode was filled with a sample and a displayed electric conductivity that became constant was determined to be a measured value.

(6) Measurement of color shift

The color tone of a liquid crystal display apparatus was measured by changing the polar angle from 0° to 80° in a direction of an azimuth angle of 45°, using “EZ Contrast 160D” (trade name, manufactured by ELDIM SA), and plotted on an XY chromaticity diagram. Further, the color tone of the liquid crystal display apparatus was measured by changing an azimuth angle from 0° to 360° in a direction of a polar angle of 60°.

(7) Measurement of contrast

A white image and a black image were displayed on the liquid crystal display apparatus, and measured by “EZ Contrast 160D” (trade name, manufactured by ELDIM SA).

### Reference Example 1

### Production of Polarizer

A polymer film “9P75R” (trade name, thickness: 75 μm, average polymerization degree: 2,400, saponification degree: 99.9 mol %, manufactured by Kuraray Co., Ltd.) containing polyvinyl alcohol as a main component was uniaxially stretched 2.5 times by using a roll stretching machine while the polymer film was colored in a coloring bath maintained at 30° C.±3° C. and containing iodine and potassium iodide. Next, the polymer film was uniaxially stretched to a 6 times length of the original length of the polyvinyl alcohol film in an aqueous solution maintained at 60° C.±3° C. and containing boric acid and potassium iodide while a cross-linking reaction was performed. The obtained film was dried in an air circulating thermostatic oven at 50° C.±1° C. for 30 minutes, to thereby obtain polarizers P1 and P2 with a moisture content of 26%, a thickness of 28 μm, a polarization degree of 99.9%, and a single axis transmittance of 43.5%.

### Reference Example 2

### Production of Polarizer Protective Film

A triacetylcellulose film “FUJITAC UZ” (tradename, thickness: 80 μm, manufactured by Fuji Photo Film Co., Ltd.) was used as a polarizer protective film.

### Reference Example 3

### Production of Optical Element (C)

A triacetylcellulose film having an in-plane retardation Re of 0 nm (manufactured by Fuji Photo Film Co., Ltd., tradename “Z-TAC (having a thickness of 80 μm)”) was immersed in an aqueous solution of sodium hydroxide, and the surface of the film was subjected to an alkali treatment (saponification treatment). The contact angle of water at 23° C. with respect to the film after the alkali treatment was 42.2° (64.6° before the treatment).

### Reference Example 4

### Synthesis of acenaphtho[1,2-b]quinoxaline (QAN)

To a reaction container equipped with a stirrer, 5 L of glacial acetic acid and 490 g of purified acenaphthenequinone were loaded, followed by stirring under nitrogen bubbling for 15 minutes, whereby an acenaphthenequinone solution was obtained. Similarly, to another reaction container equipped with a stirrer, 7.5 L of glacial acetic acid and 275 g of o-phenylenediamine were loaded, followed by stirring under nitrogen bubbling for 15 minutes, whereby an o-phenylenediamine solution was obtained. After that, the o-phenylenediamine solution was gradually added to the acenaphthenequinone solution over 1 hour while stirring under a nitrogen atmosphere, and thereafter, they were allowed to react with each other by further continuing stirring for 3 hours. Ion exchange water was added to the obtained reaction solution, and a precipitate was filtered to obtain a crude product. The crude product was recrystallized with heated glacial acetic acid to obtain purified QAN.

### Reference Example 5

### Synthesis of acenaphtho[1,2-b]quinoxaline-2-sulfonic acid(2-sulfo-QAN)

300 g of the QAN obtained in Reference Example 4 was added to 2.1 L of 30% fuming sulfuric acid, stirred at room temperature for 48 hours, whereby the mixture was allowed to react. While the obtained solution was kept at 40° C. to 50° C., 4.5 L of ion exchange water was added to the solution to dilute, and stirred for further 3 hours. A precipitate was filtered to obtain 2-sulfo-QAN.

The reaction path is shown in Formula (4).

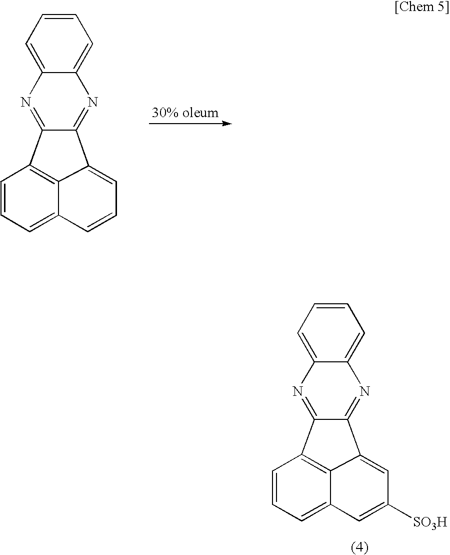

### Reference Example 6

### Synthesis of acenaphtho[1,2-b]quinoxaline-2,5-disulfonic acid(2,5-sulfo-QAN)

300 g of the QAN obtained in Reference Example 4 was added to 2.1 L of 30% fuming sulfuric acid, stirred at room temperature for 24 hours, heated to 125° C., and stirred for 32 hours, whereby the mixture was allowed to react. While the obtained solution was kept at 40° C. to 50° C., 4.5 L of ion exchange water was added to the solution to dilute, and stirred for further 3 hours. A precipitate was filtered and recrystallized with sulfuric acid to obtain 2,5-sulfo-QAN.

The reaction path is shown in Formula (5).

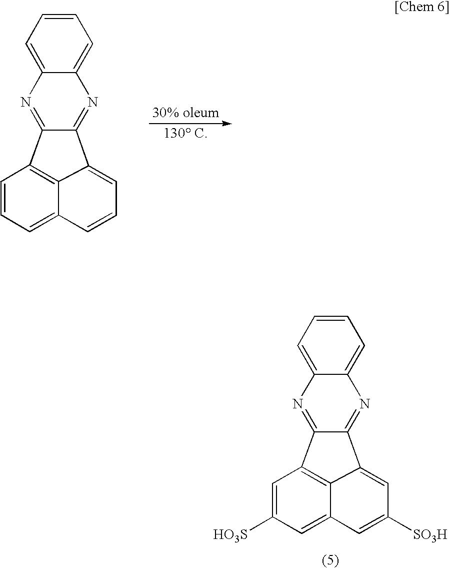

### Reference Example 7

### Preparation of Lyotropic Liquid Crystal Aqueous Solution (a)

2-sulfo-QAN obtained in Reference Example 5 and 2,5-sulfo-QAN obtained in Reference Example 6 were dissolved in 30 L of ion exchange water (electric conductivity: 0.1 μS/cm), and a sodium hydroxide aqueous solution was added to the solution to neutralize it. The obtained aqueous solution was arranged in a supply tank and circulation-filtered while reverse osmosis water was being added so as to obtain a constant liquid amount, using a high-pressure RO element test apparatus equipped with a reverse osmosis membrane filter “NTR-7430 filter element” (trade name, manufactured by Nitto Denko Corporation), and remaining sulfuric acid was removed until the electric conductivity of waste liquid reached 10 μS/cm. Next, this aqueous solution was adjusted so that the concentration of a polycylic compound in an aqueous solution became 24% by weight, using a rotary evaporator. When the aqueous solution thus obtained was observed with a polarization microscope, it exhibited a lyotropic liquid crystal phase at 23° C. When the composition ratio between the sodium salt of 2-sulfo-QAN and the sodium salt of 2,5-sulfo-QAN in the aqueous solution was quantified by liquid chromatographic analysis, the composition ratio of the sodium salt of 2-sulfo-QAN and the sodium salt of 2,5-sulfo-QAN was 35:65.

The reaction path is shown in Formulae (6) and (7).

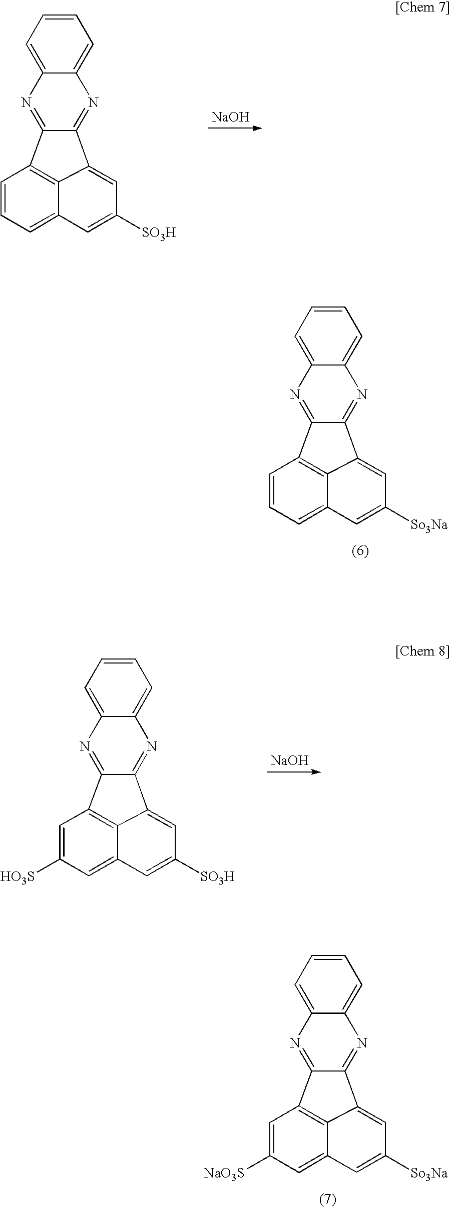

### Reference Example 8

### Production of Optical Element (D)

A product available under the trade name of “ZRF80S” from Fuji Photo Film Co., Ltd. (Re[590]=0 nm, Rth[590]=1 nm) was used as the optical element (D).

### Reference Example 9

### Production of Liquid Crystal Cell of IPS Mode

A liquid crystal panel was taken out from a liquid crystal display apparatus [KLV-17HR2 manufactured by Sony Corporation] including a liquid crystal cell of an IPS mode, polarizing plates arranged on upper and lower sides of the liquid crystal cell were removed, and glass (front and back) surfaces of the above liquid crystal cell were washed.

### Example 1

The lyotropic liquid crystal aqueous solution (a) obtained in Reference Example 7 was applied to the surface of the optical element (C) subjected to the alkali treatment obtained in Reference Example 3 using a bar coater (wire bar #4 manufactured by TESTER SANGYO CO., LTD.), and dried while air was blown to the applied surface in a thermostatic chamber at 23° C. After that, the applied surface was further dried at 40° C. for 3 minutes in an air circulating drying oven. Consequently, an optical element (A) whose refractive index ellipsoid exhibited a relationship of nx>nz>ny was obtained on the surface of the optical element (C). The thickness, Re[590], and NZ coefficient of the obtained optical element (A) were 0.9 μm, 273 nm, and 0.25, respectively.

Next, a shrinkable film was attached on each of both sides of a polymer film having a thickness of 58 μm and containing a styrene-based resin and a polycarbonate-based resin via an acrylic pressure-sensitive adhesive layer, and the resultant polymer film was stretched at 145° C. at a ratio of 1.28. After the stretching, the shrinkable film and the acrylic pressure-sensitive adhesive layer were released, whereby an optical element (B) was produced. The optical element (B) thus obtained had an Re[590] of 270 nm, an Rth[590] of 202 nm, and an Nz coefficient of 0.75.

The optical element (B) thus obtained was laminated on the optical element (A) via an acrylic pressure-sensitive adhesive (having a thickness of 20 μm).

The polarizer protective film obtained in Reference Example 2 was attached to one surface of the polarizer P1 obtained in Reference Example 1 and the optical element (C) side of the laminate of the optical element (C)/optical element (A)/optical element (B) obtained in the above was attached to the other side by roll-to-roll to obtain a polarizing plate (A). At this time, they were arranged so that a slow axis of the optical element (A) and the optical element (B) was substantially perpendicular to an absorption axis of the polarizer.

On the other hand, the polarizer protective film obtained in Reference Example 2 was attached to one surface of the polarizer P2 obtained in Reference Example 1 and the optical element (D) obtained in Reference Example 8 was attached to the other surface by roll-to-roll to obtain a polarizing plate (B).

The above polarizing plate (A) was laminated on the viewer side surface of the liquid crystal cell obtained in Reference Example 9 and the above polarizing plate (B) was laminated on the backlight side surface of the liquid crystal cell via an acrylic pressure-sensitive adhesive (thickness: 20 μm) in order to make each of the optical element (B) and optical element (D) on the side of the liquid crystal cell. At this time, they were arranged so that an absorption axis of the polarizer P1 in the polarizing plate (A) was substantially perpendicular to an absorption axis of the polarizer P2 in the polarizing plate (B). Thus, a liquid crystal panel (1) was obtained.

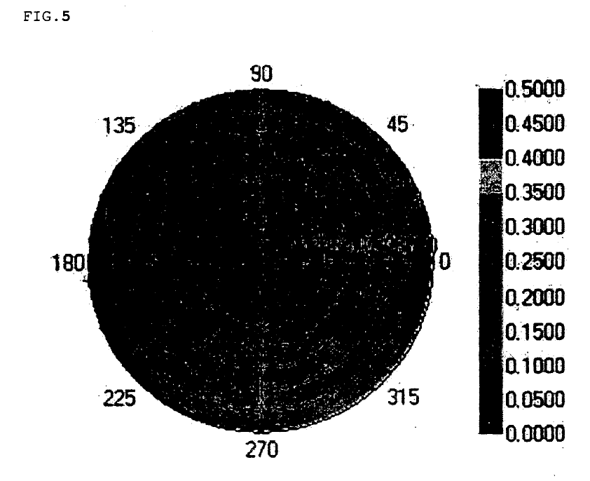

FIG. 5 shows a radar chart illustrating the contrast, light leakage, and color shift of the obtained liquid crystal panel (1).

As shown in FIG. 5, the liquid crystal panel (1) has a high contrast ratio in an oblique direction, less light leakage, and a small color shift in an oblique direction.

### Comparative Example 1

The polarizer protective films obtained in Reference Example 2 were attached to both surfaces of the polarizer P1 (or P2) obtained in Reference Example 1 by roll-to-roll to obtain a polarizing plate (C).

The above polarizing plates (C) were laminated on the surfaces of the liquid crystal cell obtained in Reference Example 9 on the viewer side and the backlight side via an acrylic pressure-sensitive adhesive (thickness: 20 μm). At this time, they were arranged so that an absorption axis of the polarizer in the polarizing plate (C) on the viewer side was substantially perpendicular to an absorption axis of the polarizer in the polarizing plate (C) on the backlight side. Thus, a liquid crystal panel (C1) was obtained.

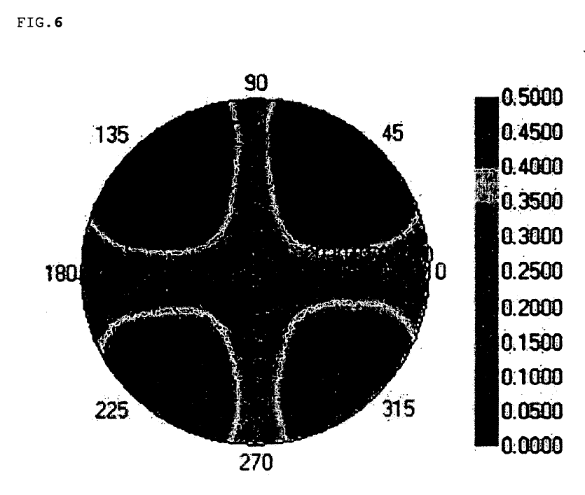

FIG. 6 shows a radar chart illustrating the contrast, light leakage, and color shift of the obtained liquid crystal panel (C1).

As shown in FIG. 6, the liquid crystal panel (C1) has a lower contrast ratio in an oblique direction, much more light leakage, and a larger color shift in an oblique direction, compared with the liquid crystal panel (1) obtained in Example 1.

### INDUSTRIAL APPLICABILITY

As described above, the liquid crystal panel of the present invention has a high contrast ratio in an oblique direction, less light leakage, and a small color shift in an oblique direction, and can be greatly reduced in thickness. Therefore, the liquid crystal panel of the present invention is considered to be very useful for the enhancement of display characteristics of a thin liquid crystal display apparatus. The liquid crystal panel of the present invention is preferably used for a liquid crystal display apparatus and a liquid crystal television.

1. A liquid crystal panel, comprising:
a liquid crystal cell;
a first polarizer arranged on one side of the liquid crystal cell;
a second polarizer arranged on the other side of the liquid crystal cell;
an optical element (A) arranged between the first polarizer and the liquid crystal cell; and
an optical element (B) arranged between the optical element (A) and the liquid crystal cell, wherein:
the optical element (A) exhibits a refractive index ellipsoid of nx>nz>ny, is formed of one or more kinds of polycyclic compounds each having a —SO₃M group and/or a —COOM group where M represents a counter ion, and has an Nz coefficient of 0.05 to 0.45; and
the optical element (B) exhibits a refractive index ellipsoid of nx>nz>ny and has an Nz coefficient of 0.55 to 0.95.

2. A liquid crystal panel according to claim 1, wherein the polycyclic compound which forms the optical element (A) has a heterocycle.

3. A liquid crystal panel according to claim 2, wherein a nitrogen atom is incorporated as a heteroatom in the heterocycle possessed by the polycyclic compound which forms the optical element (A).

4. A liquid crystal panel according to claim 3, wherein the polycyclic compound which forms the optical element (A) is represented by General Formula (1): 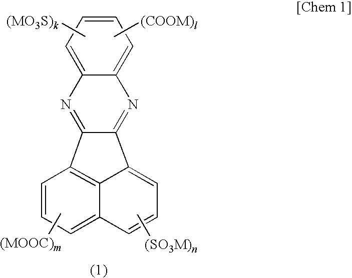
where M represents a counter ion, k and l each represent integers of 0 to 4 independently, the sum of k and l is an integer of 0 to 4, m and n each represent integers of 0 to 6 independently, the sum of m and n is an integer of 0 to 6, and k, l, m and n do not represent 0 at the same time.

5. A liquid crystal panel according to claim 1, wherein an in-plane retardation Re[590] of the optical element (A) at a wavelength of 590 nm and 23° C. is 100 to 400 nm.

6. A liquid crystal panel according to claim 1, wherein a thickness of the optical element (A) is 0.05 to 10 μm.

7. A liquid crystal panel according to claim 1, wherein the optical element (B) includes a stretched film obtained by attaching a shrinkable film on one or both sides of a polymer film and stretching the polymer film under heat.

8. A liquid crystal panel according to claim 1, wherein an in-plane retardation Re[590] of the optical element (B) at a wavelength of 590 nm and 23° C. is 100 to 400 nm.

9. A liquid crystal panel according to claim 1, wherein a thickness of the optical element (B) is 0.05 to 10 μm.

10. A liquid crystal panel according to claim 1, wherein:
the liquid crystal panel further comprises an optical element (C) between the first polarizer and the optical element (A); and
an absolute value of a thickness direction retardation value Rth[590] of the optical element (C) measured at a wavelength of 590 nm and 23° C. is 10 nm or less.

11. A liquid crystal panel according to claim 10, wherein the optical element (C) includes a polymer film containing, as a main component, at least one selected from a cellulose ester, a cycloolefin-based resin obtained by hydrogenating a ring-opening polymer of a norbornene-based monomer, an addition copolymer of a norbornene-based monomer and an α-olefin monomer, and an addition copolymer of a maleimide-based monomer and an olefin monomer.

12. A liquid crystal panel according to claim 1, wherein:
the liquid crystal panel further comprises an optical element (D) between the second polarizer and the liquid crystal cell; and
an absolute value of a thickness direction retardation value Rth[590] of the optical element (D) measured at a wavelength of 590 nm and 23° C. is 10 nm or less.

13. A liquid crystal panel according to claim 12, wherein the optical element (D) includes a polymer film containing, as a main component, at least one selected from a cellulose ester, a cycloolefin-based resin obtained by hydrogenating a ring-opening polymer of a norbornene-based monomer, an addition copolymer of a norbornene-based monomer and an α-olefin monomer, and an addition copolymer of a maleimide-based monomer and an olefin monomer.

14. A liquid crystal panel according to claim 1, wherein a slow axis of the optical element (A) is substantially perpendicular to an absorption axis of the first polarizer.

15. A liquid crystal panel according to claim 1, wherein a slow axis of the optical element (B) is substantially perpendicular to an absorption axis of the first polarizer.

16. A liquid crystal panel according to claim 1, wherein a drive mode of the liquid crystal cell is an IPS mode.

17. A liquid crystal display apparatus comprising the liquid crystal panel according to any one of claim 1.
